(19) United States
(12) Patent Application Publication
(10) Pub. No.: US 2026/0054196 A1
(43) Pub. Date: Feb. 26, 2026

(54) APPARATUS AND PROCESSES FOR SOLVENT EXTRACTION OF COAL

(71) Applicant: UNIVERSITY OF WYOMING, Laramie, WY (US)

(72) Inventors: Nykyta VOVK, Laramie, WY (US); Trina Igelsrud PFEIFFER, Laramie, WY (US); David BELL, Laramie, WY (US); Paul BEHRENS, Laramie, WY (US)

(21) Appl. No.: 19/103,251

(22) PCT Filed: Aug. 15, 2023
(86) PCT No.: PCT/US2023/030261

§ 371 Date: Feb. 12, 2025

Related U.S. Application Data
(60) Provisional application No. 63/397,967, filed on Aug. 15, 2022.

(51) Int. Cl. B01D 11/02; B01D 11/00; B01F 27/86; B01F 27/90; B01F 27/91; C10L 5/04

(52) U.S. Cl. CPC B01D 11/0226; B01D 11/0288; B01F 27/86; B01F 27/90; B01F 27/911; C10L 5/04; B01D 2011/002; B01F 2215/0422; B01F 2215/0468; B01F 2215/0472; C10L 2290/24; C10L 2290/544; C10L 2290/56

(57) ABSTRACT

Embodiments of the present disclosure generally relate to apparatus for solvent extraction of coal and to processes for solvent extraction of coal. In an embodiment, an apparatus for solvent extraction of coal is provided. The apparatus includes a plurality of stationary members coupled to a stationary shaft, each stationary member having a stationary member opening. The apparatus further includes a rotatable shaft extending through the plurality of stationary members. The apparatus further includes a plurality of rotatable members coupled to the rotatable shaft, each rotatable member paired with a stationary member, and each rotatable member has a rotatable member opening configured to rotate relative to the stationary member opening. The apparatus further includes a plurality of members for agitating materials passing through the apparatus, the members for agitating materials coupled to the rotatable shaft, each member for agitating materials positioned between the paired stationary members and rotatable members.

### FIELD

Embodiments of the present disclosure generally relate to apparatus for solvent extraction of coal and to processes for solvent extraction of coal.

### BACKGROUND

Coal is utilized in industry as both a fuel and as a source of chemicals. Such fuels and chemicals can be produced from coal by coal liquefaction or solvent extraction. Coal liquefaction and solvent extraction rely on tetralin or aromatic oils to react with the coal macrostructure to break it down into smaller molecules. Such molecules, whether further upgraded or not, can be useful as chemicals, polymers (such as carbon fibers), asphalt products, agricultural materials, construction materials, porous carbon products, and graphene products.

Conventional technologies for solvent extraction of coal are challenged by very short coal residence times (1 hour or less) in the extraction reactor. Low coal residence times result in very low yields of extracts, and the extracts produced have characteristics that do not meet various specifications such as asphalt additive specifications. As a consequence, conventional solvent extraction techniques are characterized by inefficiencies and low conversion of the coal to desirable and useful conversion products. As climate change becomes an increasing problem, coal conversion must become more cost effective and efficient.

There is a need for new and improved apparatus and processes for solvent extraction of coal.

### SUMMARY

Embodiments of the present disclosure generally relate to apparatus for solvent extraction and to processes for solvent extraction. Unlike conventional apparatus which are challenged by short coal residence times, embodiments described herein can enable, for example, coal residence times of about 4 hours or more. The longer residence times enabled by embodiments described herein can allow for improved extraction of volatiles or other products from coal. Here, the improved extraction can be observed by the higher yields of volatiles and products as well as the enhanced characteristics of the volatiles and products. In addition, unlike conventional technologies for extracting coal which are not continuous (for example, semi-batch), embodiments described herein can enable continuous counter-current extraction.

In an embodiment, a continuous-flow extraction apparatus for extracting coal with a solvent is provided. The apparatus includes an upright reactor vessel divided into a plurality of stages by pairs of horizontal circular plates, each pair of horizontal circular plates includes a stationary plate and a rotatable plate. The stationary plate has a stationary plate opening occupying a portion of less than two quadrants of the stationary plate. The rotatable plate is coupled to a rotatable shaft, the rotatable shaft extending through the stationary plate, the rotatable plate having a rotatable plate opening occupying a portion of less than two quadrants of the rotatable plate. The upright reactor vessel includes: a vessel inlet configured to receive a coal slurry entering the upright reactor vessel, the vessel inlet positioned above the plurality of stages, the coal slurry comprising coal particles and a solvent; and a vessel outlet positioned opposite the vessel inlet.

In another embodiment, an apparatus for solvent extraction of coal is provided. The apparatus includes a plurality of stationary members coupled to a stationary shaft, each stationary member having a stationary member opening, the stationary member opening does not extend over two quadrants of the stationary member. The apparatus further includes a rotatable shaft extending through the plurality of stationary members. The apparatus further includes a plurality of rotatable members coupled to the rotatable shaft, each rotatable member having a rotatable member opening, the rotatable member opening configured to rotate relative to the stationary member opening, the rotatable member opening does not extend over two quadrants of the rotatable member, the rotatable members positioned between stationary members; and a plurality of members for agitating materials passing through the apparatus, the members for agitating materials coupled to the rotatable shaft, the members for agitating materials positioned between the rotatable members and the stationary members.

In another embodiment, an apparatus for solvent extraction of coal is provided. The apparatus includes a plurality of stationary members coupled to a stationary shaft, each stationary member having a stationary member opening, the stationary member opening does not extend over two quadrants of the stationary member. The apparatus further includes a rotatable shaft extending through the plurality of stationary members. The apparatus further includes a plurality of rotatable members coupled to the rotatable shaft, wherein: each rotatable member is paired with a stationary member; and each rotatable member has a rotatable member opening, the rotatable member opening configured to rotate relative to the stationary member opening, the rotatable member opening does not extend over two quadrants of the rotatable member. The apparatus further includes a plurality of members for agitating materials passing through the apparatus, the members for agitating materials coupled to the rotatable shaft, each member for agitating materials positioned between the paired stationary members and rotatable members.

In another embodiment is provided a reactor vessel that includes apparatus described herein. In an embodiment, the reactor vessel can be used with processes described herein.

In another embodiment, a process for extracting coal is provided. The process includes introducing a coal slurry comprising coal particles and a solvent into a reactor vessel divided into a plurality of stages by pairs of horizontal circular plates, each pair of horizontal circular plates includes a stationary plate having a stationary plate opening through which coal particles pass through; and a rotatable plate having a rotatable plate opening through which the coal particles pass through, each rotatable member opening configured to rotate relative to each stationary member opening, the process further includes rotating the rotatable plate independent of the stationary plate such that the rotatable plate opening aligns with the stationary plate opening and the coal particles pass from stage to stage. The process further includes maintaining agitation in at least a portion of the stages by an agitator located in the stages. The process further includes collecting a coal extract through a first outlet of the reactor vessel and a coal residue through a second outlet of the reactor vessel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a schematic perspective view of an apparatus for solvent extraction according to at least one embodiment of the present disclosure.

FIG. 1B is the apparatus of FIG. 1A in a vertical, upright orientation according to at least one embodiment of the present disclosure.

FIGS. 2A and 2B show schematic top views of example stationary plates according to at least one embodiment of the present disclosure.

FIG. 2C is a schematic side view of an example stationary shaft according to at least one embodiment of the present disclosure.

FIGS. 3A and 3B show schematic top views of example rotatable plates according to at least one embodiment of the present disclosure.

FIG. 3C is a schematic side view of an example rotatable shaft according to at least one embodiment of the present disclosure.

FIG. 4A shows a schematic top view of an example sweeper arm according to at least one embodiment of the present disclosure.

FIG. 4B shows a schematic side view of an example sweeper arm according to at least one embodiment of the present disclosure.

FIG. 5 shows a process flow diagram of a pilot plant according to at least one embodiment of the present disclosure.

FIGS. 6A and 6B are images of example stationary plates having a pie-shaped opening and a triangular-shaped opening, respectively, according to at least one embodiment of the present disclosure.

FIGS. 6C and 6D are images of example rotatable plates having different sized openings according to at least one embodiment of the present disclosure.

FIG. 6E (top view) and 6F (side view) are images of example coal sweeper arms according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to apparatus for solvent extraction and to processes for solvent extraction. The inventors have found apparatus and processes that can enable significantly longer coal residence times during extraction as well as higher conversion to conversion products than conventional technologies.

As described above, state-of-the-art technologies for solvent extraction of coal are challenged by very short coal residence times (1 hour or less) in the extraction reactor. Such low coal residence times are due to conventional technologies lacking, for example, reactor internals that can slow coal settling through a counter-current extraction reactor. The low coal residence times result in very low yields of extracts, and the extracts produced have characteristics that do not meet various specifications, such as asphalt additive specifications among other end-product specifications. As a consequence, conventional solvent extraction techniques are characterized by inefficiencies and low conversion of the coal to desirable and useful conversion products.

In contrast, embodiments described herein can enable, for example, coal residence times of about 4 hours or more. The longer residence times can, for example, improve extraction of volatiles or other products from coal. Here, the improved extraction can be observed by the higher yields of volatiles and products as well as the enhanced characteristics of the volatiles and products extracted. The relatively high coal residence times, good yields, and advantageous characteristics of coal extracts can be achieved by embodiments of the present disclosure. For example, embodiments described herein can enable the slowing down of coal settling, and at the same time, provide sufficient agitation inside the reactor to promote good coal contact with fresh solvent. That is embodiments of the present disclosure can enable decoupling of the coal mixing or agitation from the coal settling. Briefly, and in some embodiments, such actions (the slowing down of coal settling and sufficient agitation) can be achieved by an apparatus that includes a scaffolded stationary assembly combined with a rotating stir shaft assembly. Horizontal plates of the rotating assembly and horizontal plates of the stationary assembly divide the apparatus into stages. The plates also include openings. During operation in a reactor vessel, periodic alignment of the stationary plate openings and the rotatable plate openings allow coal particles to slowly pass through the reactor vessel and the apparatus positioned therein. In addition, and in some examples, the use of agitators (such as sweeper arms or rotating impellers) can provide sufficient agitation inside the reactor to promote good coal particle contact with fresh solvent.

As used herein, the term “coal-based feedstock” refers to a feedstock at least partially derived from coal. A coal-based feedstock includes a solid, powder, slurry, liquid, residual, extract, fluid, mixture, and/or other material that has been generated at least in part from a coal source, such as run of mine coal source and/or conversion products. For example, coal can be crushed into a powder prior to processing, sieved and/or formed into a slurry. A coal-based feedstock can also include environmental reclamation by using waste fines from coal production that were backfilled into coal mines, buried or deposited in tailings ponds.

A coal-based feedstock can be subject to various physical, thermal, and/or chemical treatments to further facilitate processing of the feedstock, for example, by thermal treatment, mechanical treatment, and/or chemical treatment to produce an intermediate. A coal-based feedstock (or intermediate/derivative product thereof) can be subjected to pyrolysis and/or solvent extraction treatments. The feedstock can also act as a recycled stream from one or more of the downstream processes or intermediates (for example, solid material remaining after solvent extraction) for augmentation, so that additional products, such as liquid products, can be promoted and/or enhanced by reprocessing with less valuable or unwanted intermediate products.

As used herein, the term “coal” refers to predominately solid hydrocarbons that can contain some amount of fluid material. Coal is generally composed of hydrogen, carbon, sulfur, oxygen and nitrogen, and optionally some other elements such as metals. Coal, as described herein, can refer to bituminous coal, sub-bituminous coal, and lignite. Coal can also refer to ash or peat. In some embodiments, coal can be sourced from Powder River Basin (Wyoming, USA) or other suitable sources. The Powder River Basin coal can be very low in sulfur, such as about 0.5 wt % or less. In some embodiments, coal is selected from the group consisting of sub-bituminous coal, lignite coal, anthracite coal, and combinations thereof.

As used herein, the term “solvent extraction” refers to the process of contacting a feedstock (or intermediate/derivative product thereof) with a solvent to facilitate the extraction and/or transformation of components of the material via chemical reaction(s) and/or mass transfer processes via solubility in the solvent. In some embodiments, solvent extraction is carried out by flowing a liquid solvent or mixture of solvents through, across, or over, a feedstock (or intermediate/derivative product thereof). In some embodiments, solvent extraction can be carried out as a batch process or a continuous process by bringing a feedstock (or intermediate/derivative product thereof) in physical contact with one or more solvents.

As described herein, solvent extraction can utilize one or more solids in one or more solvent extraction steps, including in multistage solvent extractions in which the same or similar solvents are repeatedly used on a materials. Solvents, as described herein, can be pure solvents or mixtures including mixtures of solvents generated by the processes described herein. Solvents can be derived from petrochemicals or from processes that build up higher alcohols from synthesis gas. Synthesis gas can originate from coal, or from the residues after solvent extraction processes described herein. Accordingly, solvents originating from synthesis gas can further maximize utilization of coal.

Solvents, as described herein, can be mixtures of a number of solvents. Solvents can be recycled and reused. Solvent extraction may be at subcritical temperatures. Solvent extraction can be performed at reduced pressures, atmospheric pressures or increased pressures. Solvent extraction can be at carried out at supercritical pressures and temperatures.

As used herein, the term “solvent” refers to a liquid or a mixture of liquids having solubility and/or reactivity with regard to hydrocarbons or other species and molecules present in coal (or intermediate/derivative product thereof). Solvent can refer to a liquid organic solvent or hydrocarbon or a mixture of liquids, including organic solvents and mixtures of solvents. The solvents can be defined by boiling point ranges or other properties. Organic solvents can include hydrocarbon solvents, aromatic hydrocarbon solvents, solvents containing at least one hydroxyl group, such as alcohols, or combinations thereof. In embodiments utilizing two or more solvents, solvents can be distinguished by composition, additives, molecular design, boiling point ranges, or combinations thereof.

Some embodiments described herein relate to solvent extracts comprising “high value coal products”. As used herein, the term “high value coal products” can describe chemicals and materials (both solid and liquid) that are more valuable than the coal or feedstock at least partially derived from coal. High value coal products include non-fuel products, such as a product having value provided by properties, compositions, and/or uses more valuable than its ability to generate energy on combustion. High value coal products can refer to liquid products generated from predominately solid coal. High value coal products can refer to products that are not fuel (for example, created for the purpose of burning to generate energy).

Examples of high value coal products include polymers (for example, polyurethane, polyesters, polyamides), high value chemicals (for example, BTX, paraffins, olefins,), composite materials, carbon fiber, graphene, graphitic products, porous carbons, building materials, road, paving and roofing materials, and agricultural materials such as soil amendments, among others. High value coal products can represent a fraction of the total material converted from the feedstock, for example, 50% of the total products on a dry basis, 70% of the total products on a dry basis, 80% of the total products on a dry basis, or optionally, 90% of the total products on a dry basis.

The use of headings is for purposes of convenience only and does not limit the scope of the present disclosure. Embodiments described herein can be combined with other embodiments.

Illustrative, but non-limiting, examples of apparatus and processes for extracting coal and forming compositions of the present disclosure are described below.

### Apparatus

Embodiments of the present disclosure generally relate to apparatus for solvent extraction. Unlike conventional technologies characterized as having very low residence times (about 1 hour or less), embodiments described herein accommodate coal residence times of about 4 hours or more. Generally, and in some embodiments, the apparatus includes a scaffolded stationary assembly combined with a rotating stir shaft assembly. Plates of the stationary assembly and plates of the rotating assembly include orifices or openings and divides the apparatus into stages. Periodic alignment of orifices (or openings) at each stage allows coal particles to slowly pass through the reactor.

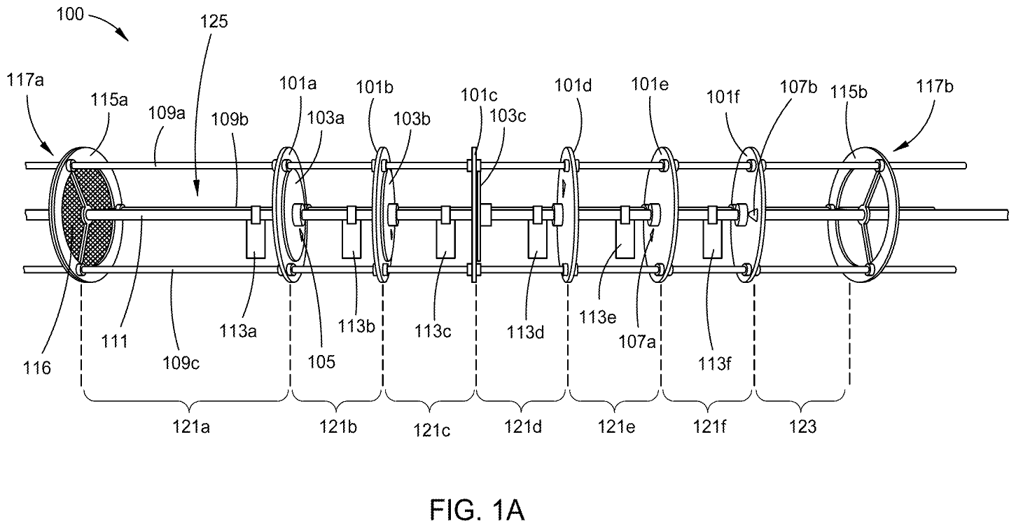

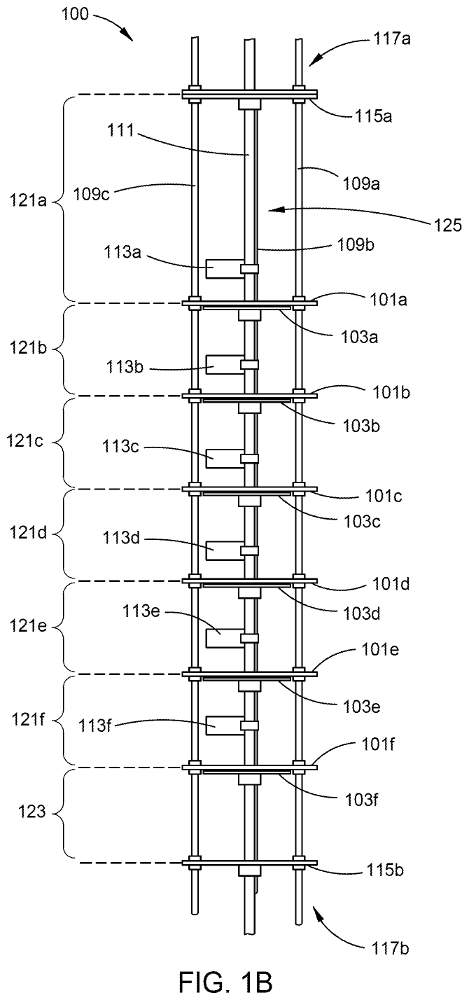

FIG. 1A is an apparatus 100 (or assembly) for solvent extraction according to at least one embodiment of the present disclosure. The apparatus 100 can be utilized to extract products, such as high value coal products, from coal. Relative to conventional technologies that are challenged by very short coal residence times (1 hour or less), the apparatus 100 can enable longer coal residence times (for example, 4 hours or more). Longer coal residence times can allow improved extraction of the coal, higher yields of coal extract(s), and/or better characteristics of the extract(s), among other advantages.

As further described below, the apparatus 100 (or assembly) can be positioned inside a reactor vessel (for example, extraction reactor 501). The reactor vessel can be a counter-current extraction reactor vessel. Alternatively, the reactor vessel can be a co-current extraction reactor vessel. In some embodiments, the reactor vessel can be a continuous flow reactor vessel or a continuous counter-current extraction reactor vessel. Alternatively, the reactor vessel can be a batch flow extraction reactor vessel or semi-batch flow extraction reactor vessel.

As shown in FIG. 1A, the apparatus 100 is not in an upright position. The view shown in FIG. 1A is used to illustrate, for example, rotatable member openings (for example, rotatable member openings 105) and stationary member openings (for example, stationary member openings 107a, 107b) as further described below. During operation, the apparatus is in a vertical, upright position and can be installed inside a reactor vessel such that the first end 117a (or top end) of the apparatus 100 is positioned above the second end 117b (or bottom end) of the apparatus 100. For clarity, the following description may describe the apparatus 100 in a vertical, upright position. FIG. 1B shows the apparatus 100 in a vertical, upright position with first end 117a as the top end of the apparatus 100 and second end 117b as the bottom end of the apparatus 100. As further described below, the coal (as, for example, a slurry) can enter the apparatus 100 above stage 121a. In one embodiment, the first end 117a is a vessel inlet and the second end 117b is a vessel outlet disposed opposite the first end 117a. Although not shown in FIG. 1B, the rotatable member openings (for example, rotatable member openings 105) and stationary member openings (for example, stationary member openings 107a, 107b), among other elements, are present in the apparatus 100.

The apparatus 100 (or assembly) includes a plurality of stationary members 101a-101f (collectively, stationary members 101). Although six stationary members are shown, more or less stationary members 101 are contemplated. The stationary members 101 can be in the form of, for example, a plate or a disc. The stationary members 101 can have any suitable shape such as circular-shaped, oval-shaped, or elliptical shape, among other shapes. The shapes and forms of the stationary members 101 can be the same or different. The stationary members 101 can be made of any suitable material such as stainless steel.

The stationary members 101 include stationary member openings 107 (or orifices, cut-outs) through which materials (for example, solvent and coal) introduced into the assembly (or reactor) can pass through. Although only two stationary member openings are shown (stationary member opening 107a and stationary member opening 107b), each of the stationary members 101 has a stationary member opening. Shapes, dimensions, and other features of the stationary member openings 107 are described below.

The apparatus 100 can further include stationary shafts 109a-109c (collectively, stationary shafts 109) to which the stationary members 101 are mounted on or otherwise coupled to. The stationary shafts 109 can be rods such as stainless steel rods. The stationary shafts 109 can serve as a stationary scaffolding to support the stationary members 101 among other elements of the apparatus 100. Although three stationary shafts are shown, more or less stationary shafts can be utilized.

The apparatus 100 can further include support rings 115a, 115b (collectively, support rings 115). The support rings can serve to support or stabilize the stationary shafts 109. The stationary members 101 and support rings 115 can be coupled to or mounted on the stationary shafts 109 by any suitable fastener or bolt. Additionally, or alternatively, stationary members 101 and support rings 115 can be welded to the stationary shafts 109. Positioned on the support ring 115a is a filter 116 which can filter the coal-based feedstock (for example, a coal slurry).

The apparatus 100 (or assembly) further includes a plurality of rotatable members 103. Although only three rotatable members are shown (for example, rotatable members 103a-103c), three other rotatable members are part of apparatus 100. That is, and in some embodiments, each stationary member is paired with a rotatable member. The rotatable members 103 are positioned near a face of the stationary members 101. As shown, the rotatable members 103 are positioned on a bottom face (or right face) of the stationary members 101.

The rotatable members 103 are smaller in at least one dimension than the stationary members 101 such that the rotatable members 103 are positioned inside a perimeter created by the stationary shafts 109. The rotatable members 103 can be in the form of, for example, a plate or a disc. The rotatable members 103 can have any suitable shape such as circular-shaped, oval-shaped, or elliptical shape, among other shapes. The shapes and forms of the rotatable members 103 can be the same or different. The rotatable members 103 can be made of any suitable material such as stainless steel.

The rotatable members 103 include rotatable member openings 105 (or orifices, cut-outs) through which materials (for example, solvent and coal) introduced into the assembly (or reactor) can pass through. Although only one rotatable member opening is shown for clarity, each of the rotatable members 103 has a rotatable member opening. During use, and as further described below, the rotatable member openings 105 rotate relative to the stationary member openings 107. Shapes, dimensions, and other features of the rotatable member openings 105 are described below.

The apparatus 100 can further include a rotatable shaft 111 to which the rotatable members 103 are mounted on or otherwise coupled to. The rotatable shaft 111 also extends through the stationary members 101. The rotatable shaft 111 can be coupled to equipment (not shown), such as a motor, for rotating the rotatable shaft 111 about its axis. Rotation of the rotatable shaft 111, in turn, rotates the rotatable members. During use, for example, the apparatus 100 is in an upright vertical position such that the rotatable shaft 111 is perpendicular to the ground. The rotatable shaft 111 has a longitudinal axis passing through the length of the rotatable shaft 111 and about which the rotatable shaft rotates. The rotatable shaft 111 can be a rod such as a stainless steel rod. The stationary shafts 109 can serve as a stationary scaffolding to support the stationary members 101 among other elements of the apparatus 100.

The apparatus can further include a plurality of members 113 for agitating, mixing, and/or stirring materials (for example, coal and solvent) that pass through apparatus 100. The plurality of members 113 can be mounted to, or otherwise coupled to, the rotatable shaft 111. The plurality of members 113 can be positioned between a stationary member and a rotatable member. The plurality of members 113 can be in the form of sweeper arms, paddles, stirrers, impellers (such as a rotating impeller), or any suitable element for agitating, mixing, and/or stirring the materials. Impellers can provide better agitating/mixing than sweeper arms if desired. In some embodiments, the static baffles can be positioned near the members 113 to improve solid-liquid contacting.

In some embodiments, one or more of the plurality of members 113 can rotate due to rotation of the rotatable shaft 111. Additionally, or alternatively, and in at least one embodiment, one or more of the plurality of members 113 can operate in an at least partially independent manner from the rotatable shaft 111. For example, the plurality of members 113 can be coupled to equipment (not shown), such as a motor, that drives the plurality of members 113 to move or rotate. That is, one or more of the plurality of members 113 can rotate at the same or different speed as the rotatable members 103. The plurality of members 113 can be driven by a variety of methods such as a variable speed drive, and the rotational speed can be adjusted to find a workable speed. Higher rotational speeds can improve solid/liquid contacting, but in some instances can interfere with coal settling, which is utilized to direct the solids down through the apparatus 100 (and reactor vessel comprising the apparatus 100).

As described above, the stationary rods can create a perimeter of the apparatus. Within this perimeter is an interior region 125 of apparatus 100. The interior region 125 of the apparatus 100 is divided into a plurality of stages and when in a reactor vessel (for example, extraction reactor 501) the reactor vessel is also divided into a plurality of stages. This plurality of stages can include stages 121a-121f (collectively, stages 121; also called drop-thru stages) and exit stage 123. More or less stages are contemplated. For example, the apparatus can have 3 or more stages 121, such as 4 or more stages 121, such as 5 or more stages 121, such as 6 or more stages 121, such as from 4 to 10 stages 121, such as from 5 to 9 stages 121, such as from 6 to 8 stages 121, such as 6 stages. In these and other embodiments, a member 113 (for example, an agitator or mixer) can be positioned in one or more of the stages 121. In some embodiments, the plurality of stages can further include a filter stage (a stage above the filter 116).

In some embodiments, an individual stage (for example, stage 121a) of the plurality of stages 121 can include a member 113 (for example a sweeper arm or impeller), a stationary member 101, and a rotatable member 103. In some embodiments, the stage can include the member 113 positioned above the stationary member 101 and the stationary member positioned above the rotatable member 103.

The apparatus 100 is divided into the plurality of stages 121 by pairs of stationary members 101 and rotatable members 103. In an upright, vertical position, the apparatus 100 (and the interior region 125 thereof) is divided into the plurality of stages by pairs of horizontal members, each pair of horizontal members including a stationary member of the plurality of stationary members 101 and a rotatable member of the plurality of rotatable members 103. Similarly, when apparatus 100 is positioned or installed in an upright, vertical position within a reactor vessel, the reactor vessel is divided into the plurality of stages by pairs of horizontal members, each pair of horizontal members including a stationary member of the plurality of stationary members 101 and a rotatable member of the plurality of rotatable members 103. In some embodiments, the horizontal members (for example, stationary members 101 and the rotatable members 103) can be in the form of circular plates or discs.

In operation, the rotatable member openings 105 can be configured to rotate relative to the stationary member openings 107 by action of the rotatable shaft 111. An internal passageway-connecting one stage to the next-opens and closes as the rotatable shaft 111 rotates, and allowing coal (in the form of particles or a slurry) to flow or drop through to the next stage when the rotatable member opening 105 is in certain positions: When the stationary member opening 107 is at least partially aligned with the rotatable member opening 105, the internal passageway is opened and the coal can pass from one stage to the next (for example, stages 121a and 121b). When the openings are not aligned, the internal passageway closes and the coal cannot pass from one stage to the next. That is, periodically aligning the openings at each stage can be used as a mechanism to allow coal particles to pass through the apparatus 100 (or the reactor vessel including apparatus 100).

In contrast to conventional technologies that do not include such openings and have very short coal residence times in the reactor (1 hour or less), embodiments of the present disclosure can enable significantly longer coal residence times. For example, residence times can be greater than 1 hour, greater than 2 hours, greater than 3 hours, greater than four hours, such as from about 4 hours to about 24 hours, such as from about 4 hours to about 20 hours, such as from about 5 hours to about 15 hours, such as from about 6 hours to about 12 hours, such as from about 7 hours to about 10 hours, such as about 9 hours, though other coal residence times are contemplated. Any of the foregoing numbers can be used singly to describe an open-ended range or in combination to describe a close-ended range. Longer coal residence times can be achieved by, for example, including more pairs of stationary members 101 and rotatable members 103.

When the coal slurry passes from one stage to the next (for example, stages 121a and 121b), the coal can settle on one or more of the stationary members 101. Such settling can prevent the coal from passing through the apparatus 100 (and reactor vessel) from the first end 117a to the second end 117b during operation. The members 113 (for example, sweeper arms or impellers) can be utilized to stir the mixture of coal and solvent and to prevent the coal from settling on the one or more of the stationary members 101. In such a manner, the apparatus 100 enables decoupling of the mixing from the settling.

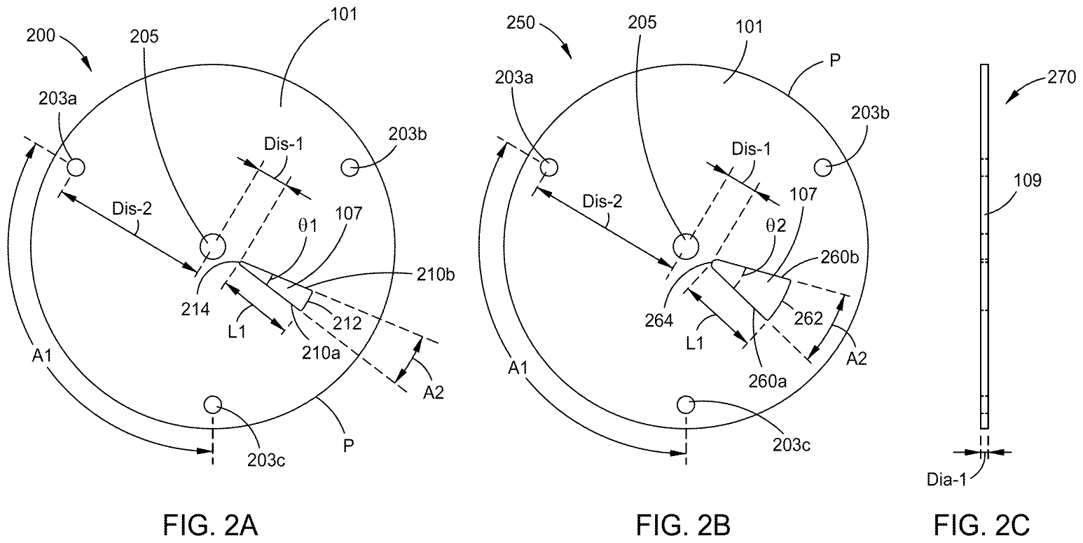

FIGS. 2A-2C, 3A-3C, and 4A-4B show schematic views and non-limiting designs of various internals of the apparatus 100 (for example, the stationary members 101, the stationary shafts 109, the rotatable members 103, the rotatable shaft 111, and the members 113). Such internals can allow coal residence times that are significantly higher than conventional technologies.

FIGS. 2A and 2B show schematic top views 200 and 250, respectively, of stationary members 101 that include stationary member openings 107 of different sizes according to at least one embodiment of the present disclosure. In these examples, the stationary members 101 are circular plates or discs, though other shapes are contemplated. In addition to the stationary member opening 107, the stationary members 101 further include openings 203a-203c (collectively, openings 203) or thru-holes through which the stationary shafts 109 extend through and couple the stationary members 101 and support rings 115. A side view 270 of a stationary shaft 109 is shown in FIG. 2C and can have any suitable diameter (shown as diameter-1 (Dia-1)). As described above, the stationary members 101 can be coupled to the stationary shafts 109 at openings 203 by any suitable fastener or bolt, or can be welded together. The stationary members 101 further include an opening 205 (or thru-hole) through which the rotatable shaft 111 extends through. The rotatable shaft 111 and the stationary members 101 are not coupled at the opening 205 such that the rotatable shaft can rotate freely within the opening 205. The stationary members 101 can be designed to be larger than the rotatable members 103.

The openings 203 of the stationary members 101 can be any suitable size. An arc length between a center of openings 203 (as shown by arc length A1), as calculated by r×θ×(π/180) can be any suitable arc length, where r is the radius of the circular plate (for example, stationary member 101) and θ is the angle (in degrees) formed between the two joining the center of the stationary member 101 to the end-points of the arc. In some embodiments, the arc length A1 can be r×θ×(π/180) where θ is from about 60° to about 180°, such as about 120°. In this equation, θ depends on the number of openings 203. The openings 203 of the stationary member 101 can be located at any suitable distance (as shown by distance-2 (Dis-2)) from the opening 205. In some embodiments, the openings 203 can be near to the outer perimeter P (outer edge) of the stationary member 101 but some distance away from the outer perimeter P of the stationary member 101.

As described above, the stationary member openings 107 can have any suitable shape such as pie-shaped, triangular-shaped, among other shapes and be of any suitable size. As shown in FIGS. 2A and 2B, the stationary member openings 107 can include a pair of sides 210a, 210b (collectively, sides 210) or a pair of sides 260a, 260b (collectively, sides 260), respectively. The pair of sides 210 (or pair of sides 260) are connected at a vertex 214 (or vertex 264). The vertex 214 has a vertex angle θ1, and the vertex 264 has a vertex angle θ2. The vertex angles θ1, θ2 are measured on an interior side of the stationary member opening 107. The pair of sides 210 of the stationary member openings 107 are connected by a third side 212 (or an arc), and the pair of sides 260 of the stationary member openings 107 are connected by a third side 262 if triangular-shaped (or an arc). Vertex angle and arc length can be the same or different.

The pair of sides 210 (or the pair of sides 260) can have a length L1 of any suitable length. Each side of the pair of sides 210 (or each side of the pair of sides 260) can have the same or different length L1. The third side 212 (or third side 262) can have any suitable length or arc length (as shown by arc length A2). Arc length A2 is calculated as described above.

In some embodiments, the vertex 214 (or vertex 264), also referred to as a tip, of the stationary member opening 107 is positioned a first distance from the center of the stationary member 101 (shown as distance-1 (Dis-1)). A side of the stationary member opening 107 (for example, third side 212 or third side 262) can be positioned a second distance from the outer perimeter P (or edge) of the stationary member 101. That is, and in some embodiments, the stationary member opening 107 does not extend to (or touch) either of the opening 205 or the outer perimeter P of the stationary member 101. As stated differently, the stationary member opening 107 can be located at a position between the opening 205 and the outer perimeter P of the stationary member 101. That is, and in some embodiments, the length (or path) of any side of the stationary member opening 107 (for example, any of side 210a, side 210b, third side 212) does not cross more than half of the stationary member 101.

The vertex angles θ1, θ2 of the stationary member openings 107 can be any suitable angle such as greater than 0° and less than 180°, such as about 90° or less, such as about 75° or less, such as about 60° or less, such as about 45° or less, or from greater than 0° to about 60°, such as from about 5° to about 45°, such as from about 10° to about 40°, such as from about 15° to about 35°, such as from about 20° to about 30°, or from about 10° to about 30°, such as about 15° or about 29°, though other values are contemplated. Any of the foregoing numbers can be used singly to describe an open-ended range or in combination to describe a close-ended range.

Due to the vertex angles θ1, θ2 of the stationary member opening 107, and in some embodiments, a stationary member opening 107 does not extend over two quadrants of the stationary member 101. Stated differently, and in some embodiments, the stationary member opening 107 occupies a portion within two quadrants or less of the stationary member 101, such as within one quadrant of the stationary member 101. The quadrants are one of four sections of the stationary member 101 made by dividing the area of the stationary member 101 with two perpendicular lines at the opening 205 through which the rotatable shaft 111 extends through.

It is contemplated that a stationary member 101 can have more than one stationary member opening 107.

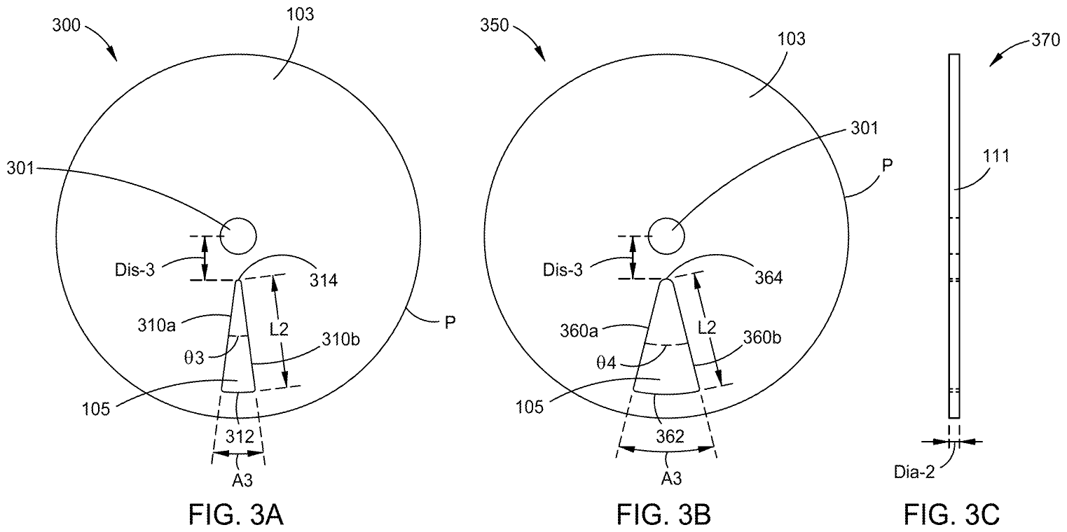

FIGS. 3A and 3B show schematic top views 300 and 350, respectively, of rotatable members 103 that include rotatable member openings 105 of different dimensions according to at least one embodiment of the present disclosure. In these examples, the rotatable members 103 are circular plates or discs, though other shapes are contemplated. In addition to the rotatable member opening 105, the rotatable members 103 further include an opening 301 through which the rotatable shaft 111 extends through. A side view 270 of the rotatable shaft 111 is shown in FIG. 3C and can have any suitable diameter (shown as diameter-1 (Dia-2)). The rotatable members 103 can be coupled to the rotatable shaft 111 at opening 301 by any suitable fastener or bolt. Additionally, or alternatively, rotatable members 103 can be welded to the rotatable shaft 111. The rotatable members 103 can be designed to be smaller than the stationary members 101.

As described above, the rotatable member openings 105 can have any suitable shape such as pie-shaped, triangular-shaped, among other shapes and be of any suitable size. As shown in FIGS. 3A and 3B, the rotatable member openings 105 can include a pair of sides 310a, 310b (collectively, 310) or a pair of sides 360a, 360b (collectively, 360), respectively. The pair of sides 310 (or pair of sides 360) are connected at a vertex 314 (or vertex 364). The vertex 314 has a vertex angle θ3, and the vertex 364 has a vertex angle θ4. The vertex angles θ3, θ4 are measured on an interior side of the rotatable member opening 105. The pair of sides 310 of the rotatable member opening 105 are connected by a third side 312 (or an arc), and the pair of sides 360 of the rotatable member opening 105 are connected by a third side 362 if triangular-shaped (or an arc). The pair of sides 210 or (the pair of sides 260) can have a length L1 of any suitable length. Each side of the pair of sides 310 or (each side of the pair of sides 260) can have the same or different length L2. The third side 212 (or third side 262) can have any suitable length or arc length (as shown by arc length A3). Arc length A3 is calculated as described above. Vertex angle and arc length can be the same or different.

In some embodiments, the vertex 314 (or vertex 364), also referred to as a tip, of the rotatable member opening 105 is positioned a first distance from the center of the rotatable member 103 (shown as distance-3 (Dis-3)). A side of the rotatable member opening 105 (for example, third side 312 or third side 362) can be positioned a second distance from outer perimeter P (or edge) of the rotatable member 103. That is, and in some embodiments, the rotatable member opening 105 does not extend to (or touch) either of the opening 301 or the outer perimeter P of the rotatable member 103. As stated differently, the rotatable member opening 105 can be located at a position between the opening 301 and the outer perimeter P of the rotatable member 103. That is, and in some embodiments, the length (or path) of any side of the rotatable member opening 105 (for example, any of side 310a, side 310b, or side 312) does not cross more than half of the rotatable member 103.

The vertex angles θ3, θ4 of the rotatable member openings 105 can be any suitable angle such as greater than 0° and less than 180°, such as about 90° or less, such as about 75° or less, such as about 60° or less, such as about 45° or less, or from greater than 0° to about 60°, such as from about 5° to about 45°, such as from about 10° to about 40°, such as from about 15° to about 35°, such as from about 20° to about 30°, or from about 10° to about 30°, such as about 15° or about 29°, though other values are contemplated. Any of the foregoing numbers can be used singly to describe an open-ended range or in combination to describe a close-ended range.

Due to the vertex angles Θ3, θ4 of the rotatable member opening 105, and in some embodiments, a rotatable member opening 105 does not extend over two quadrants of the rotatable member 103. Stated differently, and in some embodiments, the stationary member opening 107 occupies a portion within two quadrants or less of the rotatable member 103, such as within one quadrant of the rotatable member 103. The quadrants are one of four sections of the rotatable member 103 made by dividing the area of the rotatable member 103 with two perpendicular lines at the opening 301 through which the rotatable shaft 111 extends through.

It is contemplated that a rotatable member 103 can have more than one rotatable member opening 105.

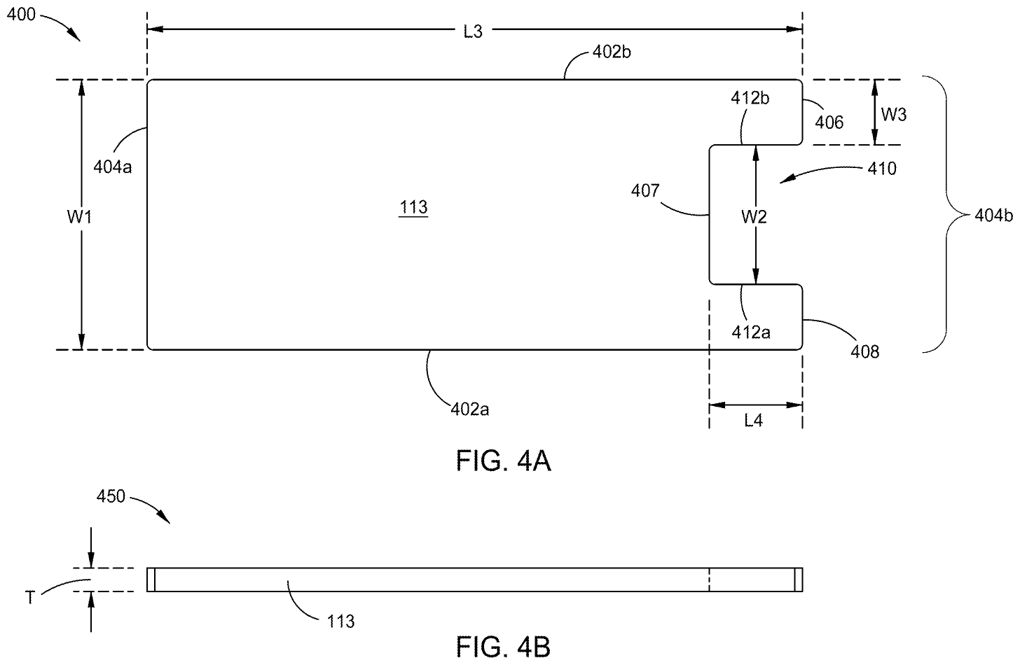

FIG. 4A shows a schematic top view 400 of the member 113 for agitating materials (for example, a sweeper arm) according to at least one embodiment of the present disclosure. The member 113 can be in the form of a sweeper arm, a paddle, a stirrer, an impeller (such as a rotating impeller), or any suitable element for agitating, mixing, and/or stirring the materials (for example, coal and/or solvent) that pass through apparatus 100 (and a reactor vessel having apparatus 100 positioned therein). The member 113 can be configured to prevent, or at least mitigate, settling of coal particles or solids on the surfaces of the stationary members 101 and/or rotatable members 103. The member 113 can be made from any suitable material such as stainless steel.

In some embodiments, the member 113 can be placed at a location that is about 15% to about 40%, such as from about 20% to about 35%, such as from about 25% to about 33% of the distance from the bottom of the stage 121%, though other values are contemplated. Any of the foregoing numbers can be used singly to describe an open-ended range or in combination to describe a close-ended range. For example, stage 121b has a distance from stationary member 101b (the bottom of stage 121b) and rotatable member 103a (the top of stage 121b). The member 113 can be placed at a location in stage 121b that is from about 15% to about 40% of the distance between the stationary member 101b and rotatable member 103a, the location being nearer to the stationary member 101b.

Referring to FIG. 4A, the sweeper arm (for example, member 113) can include a first pair of opposing sides 402a, 402b and a second pair of opposing sides 404a, 404b perpendicular to the first pair of opposing sides 402a, 402b. For clarity, description of FIG. 4A is made with reference to a sweeper arm as an example of the member 113. However, embodiments of FIG. 4A should not be limited to sweeper arms.

The sweeper arm has a width W1 and a length L3. The width W1 is a height when positioned on the rotatable shaft 111. The width W1 (or height) of the sweeper arm is smaller than the height of a stage 121. In some embodiments, the width W1 is from about 5% to about 40% of the height of the stage, such as from about 10% to about 35%, such as from about 15% to about 30%, such as from about 20% to about 25%, though other values are contemplated. Any of the foregoing numbers can be used singly to describe an open-ended range or in combination to describe a close-ended range.

The length L3 of the sweeper arm (as an example of the member 113) can be shorter than Dis-2, the distance between opening 203 of the stationary member 101 for the stationary shaft 109 and the opening 205 of the stationary member 101 for the rotatable shaft 111. In some examples, the length L3 can be from about 50% to about 90% of Dis-2, such as from about 60% to about 80%, such as from about 65% to about 75%, though other values are contemplated. Any of the foregoing numbers can be used singly to describe an open-ended range or in combination to describe a close-ended range.

Side 404b of the sweeper arm includes a first side 406 of width W3 a second side 408 of width W3, and an indent 410 (or tab). The first side 406 and the second side 408 are parallel to the second pair of opposing sides 404 of the sweeper arm. The indent 410 (or tab) can be used to couple the sweeper arm to the rotatable shaft 111 by any suitable fastener or bolt. Additionally, or alternatively, member 113 can be welded to the rotatable shaft 111. For example, the indent 410 (or tab) to provide space for a shaft collar to be welded to the member 113. The indent 410 is cut into the member and can include a pair of opposing sides 412a, 412b (each having a length L4) that are parallel to the first pair of opposing sides 402a, 402b of the sweeper arm. The indent 410 also includes a side 407 perpendicular to the pair of opposing sides 412a, 412b and has a width W2 that is less than the width W1.

FIG. 4B shows a schematic side view 450 of an example sweeper arm (for example, member 113) according to at least one embodiment of the present disclosure. The member 113 can have any suitable thickness T, such as from about 0.01 inches to about 0.1 inches, such as from about 0.03 inches to about 0.08 inches, such as about 0.06 inches, though other values are contemplated. Any of the foregoing numbers can be used singly to describe an open-ended range or in combination to describe a close-ended range.

The stationary members 101 can have any suitable outside diameter. For example, the outside diameter of the stationary members 101 can be from about 3 inches to about 20 inches, such as from about 5 inches to about 10 inches, such as from about 5 inches to about six inches, such as about 5.7 inches, though other values are contemplated. Any of the foregoing numbers can be used singly to describe an open-ended range or in combination to describe a close-ended range.

Openings 203 of the stationary members 101 can have any suitable diameter such as from about 0.1 inches to about 1 inch, such as from about 0.2 inches to about 0.6 inches, such as about 0.2 inches to about 0.3 inches, though other values are contemplated. Any of the foregoing numbers can be used singly to describe an open-ended range or in combination to describe a close-ended range.

Depending on the number of openings 203, the openings 203 can be suitably spaced apart such as about 60° to about 180°, such as about 90° to about 150°, such as about 120°. The openings 203 can be sufficiently spaced from the center of the stationary member 101 to accommodate the rotatable member 103.

Opening 205 of the stationary members 101 can have any suitable diameter such as from about 0.1 inches to about 2 inches, such as from about 0.2 inches to about 1 inch, such as from about 0.3 inches to about 0.4 inches, though other values are contemplated. Any of the foregoing numbers can be used singly to describe an open-ended range or in combination to describe a close-ended range.

The stationary member opening 107 can have any suitable dimensions. The dimensions of the stationary member opening 107 depend on, for example, the size of the stationary members 101. As defined by Dis-2, The tip (or vertex 214) can be positioned from the opening 205 at a distance of about 0.1 inches to about 2 inches from the opening 205 such as from about 0.2 inches to about 1 inch, such as from about 0.3 inches to about 0.8 inches, such as about 0.5 inches, though other values are contemplated. Any of the foregoing numbers can be used singly to describe an open-ended range or in combination to describe a close-ended range. The length L1 of sides 210 or sides 260 can be any suitable length, such as from about 0.3 inches to about 5 inches, such as from about 0.5 inches to about 2.5 inches, such as from about 1 inch to about 2 inches, such as about 1.18 inches or about 1.2 inches, though other values are contemplated. Any of the foregoing numbers can be used singly to describe an open-ended range or in combination to describe a close-ended range. Various vertex angles θ1, θ2 for the stationary member opening 107 are described above.

The rotatable members 103 can have any suitable outside diameter. In some embodiments, the rotatable members 103 are smaller in diameter than the stationary members 101. For example, the outside diameter of the rotatable members 103 can be from about 2 inches to about 15 inches, such as from about 3.5 inches to about 7 inches, such as about 4 inches though other values are contemplated. Any of the foregoing numbers can be used singly to describe an open-ended range or in combination to describe a close-ended range.

In some embodiments, the dimensions of the rotatable member opening 105 can be matched (or ±10%) of those dimensions of the stationary member opening 107. In some embodiments, dimensions of the opening 301 of the rotatable members 103 can be matched (or ±10%) of the dimensions of the opening 205 of the stationary members 101.

The dimensions for the stationary members, rotatable members, stationary shafts, rotatable shafts, members, and components thereof (for example, openings) are contemplated to be scaled accordingly for larger reactor vessels.

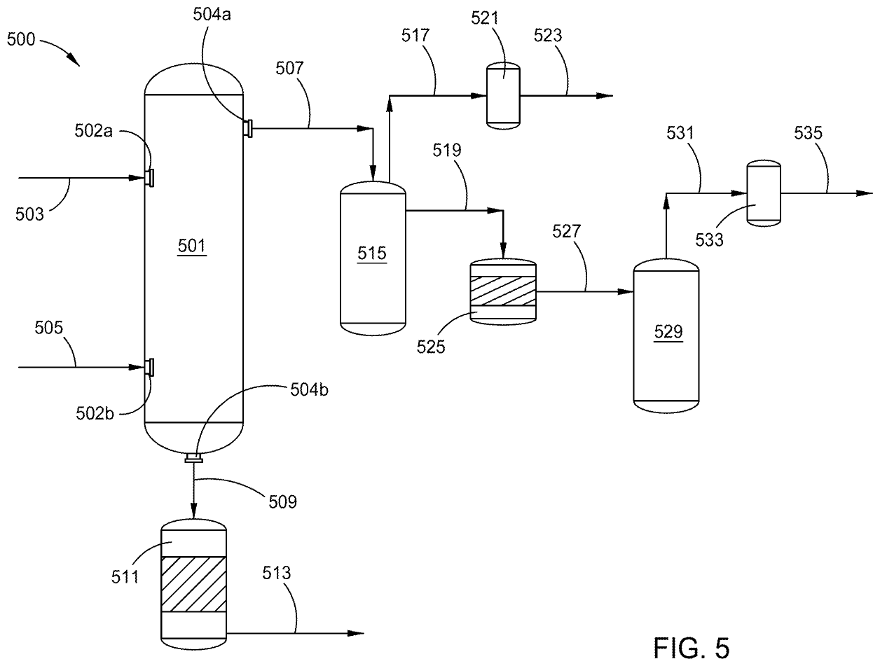

FIG. 5 shows a process flow diagram of a plant 500 according to at least one embodiment of the present disclosure. The plant 500 includes an extraction reactor 501 (a reactor vessel) where coal-based feedstocks into compositions comprising high value coal products. The extraction reactor 501 can be a counter-current coal extraction reactor, a continuous coal extraction reactor, or a continuous counter-current extraction reactor. In operation, compositions described herein can be formed or produced utilizing any suitable reactor. An illustrative, but non-limiting, example of a reactor includes a Swagelok tube reactor.

The extraction reactor 501 includes a coal slurry inlet 502a and a solvent inlet 502b. Coal slurry is introduced or injected into the extraction reactor 501 via a line 503 and coal slurry inlet 502a. The coal slurry can include a coal-based feedstock (for example, coal solids or coal particles) dispersed in a solvent. Coal slurry can be fed from a feed slurry tank (not shown) to the extraction reactor 501 by a pump positioned along the line 503.

In some embodiments, the coal slurry can be fed to the extraction reactor 501 by a ball valve, pneumatically driven pump coupled to the line 503. An illustrative, but non-limiting, example of a pump utilized to introduce or inject the solvent to the extraction reactor 501 can include a Moyno progressive cavity dosing pump, though other pumps are contemplated. Moyno progressive cavity dosing pump are capable of pumping high solids slurries. The pump to feed the coal slurry can have a variable speed drive to control the feed rate.

Solvent is introduced or injected into the extraction reactor 501 via a line 505 and solvent inlet 502b. The solvent can be fresh solvent, recycled solvent, or combinations thereof. Solvent can be fed from a solvent tank (not shown) to the extraction reactor 501 by a pump positioned along the line 505. In some embodiments, the solvent can be fed to the extraction reactor 501 by a ball valve, pneumatically driven pump coupled to the line 5005. An illustrative, but non-limiting, example of a pump utilized to introduce or inject the solvent to the extraction reactor 501 can include a Moyno progressive cavity dosing pump, though other pumps are contemplated. In some embodiments, the feed slurry tank and/or the solvent tank is at ambient temperature and pressure (for example, 25° C. and 1 bar). In these and other embodiments, pre-heaters can be positioned along the lines 503, 505.

In some embodiments, the extraction reactor 501 is designed as a counter-current extraction reactor, with coal solids or particles entering the extraction reactor 501 near the top of the extraction reactor 501 and falling down through the extraction reactor 501. Most of the solvent (aside from the solvent used to slurry the feed coal), enters the extraction reactor 501 near the bottom of the vessel, so liquid flows up the vessel, contacting the coal solids or particles falling down the extraction reactor 501. That is, solvent entering at the bottom of the extraction reactor 501 can travel upward in a counter-current manner against a downflow of coal slurry (or coal particles/solids). Accordingly, and in some embodiments, a means for injecting solvent in a counter-current manner to the flow of the coal slurry (or coal particles/solids) such as a hydraulic gear pump or other suitable equipment can be utilized to pump the solvent to the extraction reactor 501.

The process conditions during extraction in the extraction reactor can be adjusted to control yields, composition, and product properties, for example, to provide tunable control of the identity and properties of the products. In some embodiments, a coal-based feedstock is split into at least 2 fractions including: (1) Coal residue: a component that does not dissolve in the solvent(s) under the solvent extraction conditions; and (2) solvent soluble: a component that dissolves in the solvent(s) under the solvent extraction conditions and is generally soluble in the liquid solvent(s).

Referring back to FIG. 5, the extraction reactor 501 further includes a product outlet 504a and a coal residue outlet 504b. Coal residue can be removed from the bottom of the extraction reactor 501 by coal residue outlet 504b and a line 509. The coal residue may be in the form of a slurry. The coal residue can include a component that does not dissolve in the solvent(s) under the solvent extraction conditions. Solvent soluble components (the solvent and the dissolved coal species (for example, solvent extract of coal)) can be removed from the extraction reactor via the product outlet 504a and a line 509. The solvent soluble components can be in the form of a solution. In some embodiments, coal residue can be removed by use of a Moyno pump. In some embodiments, a fast action pneumatic ball valve with spring return can be implemented at the bottom of the reactor in place of the Moyno pump. The valve can be pulsed intermittently to let out slugs of residue. Here, the pressure difference between the reactor and residue filter 511 can provide the fluid velocity to carry the slurry to the residue filter inlet.

Apparatus 100 is positioned in extraction reactor 501 in an upright, vertical manner such that the first end 117a (or top end) of the apparatus 100 is positioned above the second end 117b (or bottom end) of the apparatus 100. Here, the coal slurry inlet 502a is positioned nearer to the first end 117a of the apparatus 100 and the coal residue outlet 504b is positioned nearer to the second end 117b of the apparatus 100.

In some embodiments, the coal slurry inlet 502a is positioned above the plurality of stationary members 101 and the plurality of rotatable members 103 of the apparatus 100 (for example, above the stage 121a). In at least one embodiment, product outlet 504a (also referred to as a coal extract outlet) can be positioned above one or more of the plurality of stationary members and plurality of rotatable members (for example, above the stage 121a). In some embodiments, the coal residue outlet 504b can be positioned below the plurality of stationary members and the plurality of rotatable members (for example, below the stage 121f).

Coal residue can exit the stages 121 of apparatus 100 and the extraction reactor 501 and enter a residue filter 511 via the line 509 coupled to the extraction reactor 501. At the residue filter 511, the coal residue can be washed and recovered solvent can be, for example, fed to a solvent tank or flash evaporator as indicated by line 513. In some embodiments, coal residue can be removed from the extraction reactor 501 as a slurry via line 509 and a coal residue slurry pump (not shown). The coal residue slurry pump can be a Moyno-style progressive cavity pump or a Moyno dosing pump. In some examples, a butt-weld union can be utilized to facilitate a smooth transition for the exiting coal residue slurry out through the bottom of the extraction reactor 501.

The solution (the solvent and the dissolved coal species (for example, solvent extract of coal)) exiting the extraction reactor 501 via line 507 can contain a wide range of dissolved coal components with varying degrees of solubility, boiling points, and molecular weights. This can be used to fractionate the extracted product into multiple product streams. In some embodiments, a staged reduction in temperature (resulting in pressure reductions) or partial evaporation of solvent can be used to fractionate the dissolved coal into any number of product streams. A reason for doing this is to improve the properties of the solvent extraction products so that high quality final products can be made and isolated.

In some embodiments, the solvent soluble components leaving the extraction reactor via line 507 can be separated into the extracted product and a recycle solvent. Any suitable approach can be utilized to carry out the separation. For example, the solvent soluble components (as a solution) can enter a separator 515 (such as a high temperature flash evaporator) and flashed in the separator 515 to produce solvent vapor (exiting the separator 515 via line 517) and a relatively low vapor pressure product (exiting the separator 515 via line 519). Solvent vapor can be condensed to a liquid in condenser 521 coupled to line 517. After condensing, the solvent liquid exit the condenser 521 via line 523 and can be recycled or stored for further use.

The product slurry exiting the separator 515 via line 519 can travel through optional product filter 525 coupled to the line 519 where it can contact wash solvent. The resulting mixture (containing desired products) can be fed to optional separator 529 (such as a low temperature flash evaporator or vacuum distillation tower) via line 527 coupling the optional separator 529. Insolubles at the optional product filter 525 can exit the optional product filter 525 via a line (not shown).

The mixture (containing desired products) fed to the optional separator 529 can be separated into different components. A first component, such as a solvent vapor, can exit the optional separator 529 via line 531, be condensed to a liquid in condenser 533 and exit the condenser via a line 535 at which point the solvent liquid can be recycled or stored for further use. A second component including the solvent soluble components (desired products) can be removed from the optional separator 529 via a line (not shown).

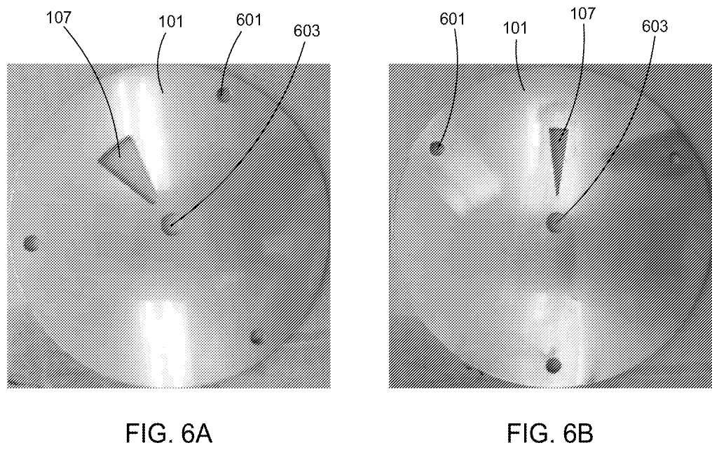

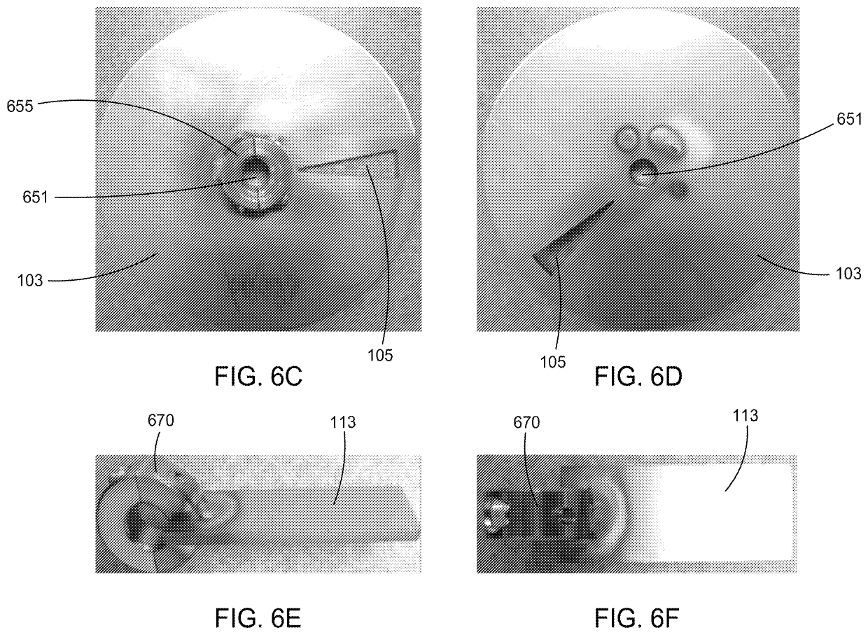

FIGS. 6A-6F show images of various internals of the apparatus (for example, apparatus 100). Specifically, FIGS. 6A and 6B are images of example stationary plates having a pie-shaped opening (for example, stationary member opening 107) and a triangular-shaped opening (for example, stationary member opening 107), respectively. As shown in the figures, these stationary plate openings are also differently sized. The stationary plates or discs are examples of stationary members 101. In addition to the stationary plate openings, the example stationary plates also include an opening 603 (or thru-hole) through which a rotatable shaft (for example, rotatable shaft 111) extends through. Opening 603 of FIGS. 6A and 6B can correspond to opening 205 of the stationary member 101. The example stationary plates also include an openings 603 (or thru hole) for the stationary shafts (for example, stationary shafts 109). The openings 603 of FIGS. 6A and 6B can correspond to opening 203 of the stationary member 101.

FIGS. 6C and 6D are images of example rotatable plates having different sized rotatable member openings 105. In addition to the rotatable plate openings, the example rotatable plates also include an opening 651 (or thru-hole) through which a rotatable shaft (for example, rotatable shaft 111) extends through. Opening 651 of FIGS. 6C and 6D can correspond to opening 301 of the rotatable member 103. The example stationary plates also include an element 655 for mounting rotatable member 103 onto the rotatable shaft. In this example, the element 655 is welded onto the rotatable member 103.

FIG. 6E (top view) and 6F (side view) are images of example coal sweeper arms (as examples of members 113) according to at least one embodiment of the present disclosure. The example coal sweeper arms in this embodiment includes an element 670 (for example, a collar such as a stainless steel collar) for mounting the sweeper arm onto rotatable shaft 111. In this example, the element 670 is welded onto the member 113 at an indent or tab (for example, indent 410) of the member 113. The plurality of members 113 can rotate independently of the rotatable. As described herein, the member 113 can rotate to help mitigate settling of coal as the coal travels through stages 121 of the apparatus 100. For example, rotation of the members 113 can help keep the coal that reaches a certain depth moving towards the stationary member openings 107 cut out of the larger stationary members (for example, stationary members 101).

Embodiments of apparatus described herein, such as apparatus 100, plant 500, and extraction reactor 501, can be utilized with embodiments of processes described herein.

### Processes

Embodiments of the present disclosure also generally relate to processes for extracting coal. Coal solvent extraction can be a useful step in processing or converting coal-based feedstocks into compositions comprising high value products. Products from coal solvent extraction can result in end products and/or intermediates useful to produce salable end products. Processes described herein can be utilized with the apparatus 100 and a reactor vessel (for example, the extraction reactor 501 of plant 500).

As described above, apparatus 100 can be positioned within reactor vessel. The apparatus 100 divides the reactor vessel into a plurality of stages (for example, stages 121) by pairs of horizontal circular plates. Each pair of horizontal circular plates includes a stationary member 101 (for example, a stationary plate) having a stationary member opening 107 (for example, a stationary plate opening) through which the coal slurry passes through. Each pair of horizontal circular plates also includes a rotatable member 103 (for example, a rotatable plate) having a rotatable member opening 105 (for example, a rotatable plate opening) through which the coal slurry passes through, each rotatable member opening configured to rotate relative to each stationary member opening.

In some embodiments, the process includes introducing coal into a reactor vessel (for example, the extraction reactor 501). The coal can be in the form of a coal slurry. The coal slurry can be introduced via coal slurry inlet 502a of the extraction reactor positioned above the plurality of stationary members 101 and the plurality of rotatable members 103 of the apparatus 100 (for example, above the stage 121a). In some embodiments, the coal slurry can be pumped into the extraction reactor 501 using a ball valve, pneumatically driven pump coupled to the line 503. Solvent can be injected into the extraction reactor through a solvent inlet (for example, solvent inlet 502b). In some embodiments, solvent can be introduced or injected into the extraction reactor through solvent inlet 502b positioned below the plurality of stages 121 such that the solvent contacts the coal in a counter-current manner in the plurality of stages 121.

The process can further include rotating the rotatable members 103 (for example, the rotatable plates) independent of the stationary members 101 (for example, the stationary plates) such that the rotatable plate opening aligns with the stationary plate opening. When the rotatable plate opening aligns with the stationary plate opening, the coal can pass from stage to stage of the plurality of stages 121, for example, by dropping through the stages 121. During rotation, the coal can pass through the drop-down stages (for example, stages 121) while the rotatable shaft rotates.

The process can further include operating the member 113 for agitating materials (for example, an agitator such as a sweeper arm, rotating impeller, etc.). Here, for example, operating the member 113 can include stirring, mixing, or otherwise agitating the coal slurry in the stages 121 by action of the members 113. In some embodiments, operating the member 113 can include maintaining agitation in at least one stage of the plurality of stages 121 by a member 113 located within the stages 121. The members 113 can also help mitigate settling of the coal on the stationary members 101 as the coal slurry drops through the stages 121 of the apparatus 100. Agitation of the coal slurry in the stages 121 can facilitate liquefying the coal and extracting products from the coal.

The process can further include collecting a coal extract through a first outlet (for example, the product outlet 504a) of the reactor vessel. Coal extract can include a solvent soluble component, for example, a component that dissolves in the solvent(s) under the solvent extraction conditions and is generally soluble in the liquid solvent(s). Coal extract can include desired products such as high value coal products. Coal extract exiting the extraction reactor 501 through the product outlet 504a can be in the form of a solution. The coal extract can include polyols, polyurethanes, polyamides, polyesters, epoxy polymers precursors thereof, derivatives thereof, or combinations thereof. The coal extract can include can include a fuel product, a non-fuel product, a polymer or polymer precursor, a high value chemical, a composite material, a carbon fiber or a graphene product, a construction material, precursors thereof, or combinations thereof.

The process can further include collecting a coal residue through a second outlet (for example, the coal residue outlet 504b) of the reactor vessel. The coal residue collected can be in the form of a coal residue slurry. The coal residue includes a component that does not dissolve in the solvent(s) under the solvent extraction conditions.

Prior to extraction, the coal-based feed can be prepared via one or more pre-extraction treatments and/or processes. Pre-extraction treatments can include mechanical treatment (for example, pulverizing, grinding, sieving, mixing, and/or formation of a slurry, among others), thermal treatment (for example, drying, heating, and/or pyrolysis, among others) and/or chemical treatment (for example, solvent extraction, and/or chemical reaction, among others).

Prior to extraction, the coal can be ground and sieved, for example, to a particle size range of about 10 mesh to about 60 mesh (about 250 to 2,000 microns in size). The coal or a derivative thereof can be dried in an oven, for example, by heating to a temperature greater than about 60° C. for a time period greater than about 10 hours, such as heating to a temperature of about 60° C. to about 120° C. for a time period of about 10 hours to about 70 hours. In some examples, the coal can be dried at about 90° C. for about 48 hours to remove moisture. In some examples, the drying can be performed under a reduced pressure using a vacuum.

After the optional pre-extraction treatment, the coal-based feedstock (which can be in the form of a slurry) can be introduced to the reactor vessel (for example, extraction reactor 501). The coal slurry can be introduced to the extraction reactor 501 at a feed rate that is from about 0.5 kg/h to about 1,000 kg/h, such as from about 1 kg/h to about 10 kg/h, such as from about 2 kg/h to about 8 kg/h, such as from about 4 kg/h to about 6 kg/h, such as about 5 kg/h, or from about 100 kg/h to about 1,000 kg/h, such as from about 300 kg/h to about 800 kg/h, such as from about 500 kg/h to about 700 kg/h, or from about 800 kg/h to about 900 kg/h, though other values are contemplated. Any of the foregoing numbers can be used singly to describe an open-ended range or in combination to describe a close-ended range.

Solvent can be introduced to the reactor vessel (for example, extraction reactor 501) at flow rate that is from about 1 kg/h to about 10,000 kg/h, such as from about 5 kg/h to about 33 kg/h, such as from about 20 kg/h to about 200 kg/h, such as from about 50 kg/h to about 175 kg/h, such as from about 75 kg/h to about 150 kg/h, such as from about 100 kg/h to about 125 kg/h, or from about 1,000 kg/h to about 10,000 kg/h, such as from about 3,000 kg/h to about 8,000 kg/h, such as from about 5,000 kg/h to about 7,000 kg/h, or from about 8,000 kg/h to about 9,000 kg/h, though other values are contemplated. In at least one example, the solvent flow rate can be about 6 kg/h. Any of the foregoing numbers can be used singly to describe an open-ended range or in combination to describe a close-ended range.

In at least one embodiment, the solvent can include a hydrocarbon solvent, an aromatic hydrocarbon solvent, a polar solvent, a hydrogen donating solvent, or combinations thereof. In some embodiments, the one or more solvents can include 1-dodecanol, tetralin (1,2,3,4-tetrahydronaphthalene), 1-methyl-naphthalene, dimethylformamide, dimethyl sulfoxide, toluene, or any combination of these. In some embodiments, the solvent utilized can be a hydrocarbon solvent, an aromatic hydrocarbon solvent, an alcohol solvent (a solvent containing at least one hydroxyl group), or combinations thereof. In some examples, the solvent includes tetralin, dodecanol (lauryl alcohol), or combinations thereof. In at least one embodiment, the one or more solvents can at least partially include one or more recycle streams derived from a coal treatment process.

The one or more solvents can be a pure solvent or a mixture of solvents. In some embodiments, and when the solvent includes two or more solvents, the proportions of at least two of the solvents in the solvent mixture can be from about 9:1 to about 1:9, such as form about 8:2 to about 2:8, such as form about 7:3 to about 3:7, such as form about 6:4 to about 4:6, such as about 1:1, though other values are contemplated. Any of the foregoing numbers can be used singly to describe an open-ended range or in combination to describe a close-ended range.

In at least one embodiment, the solvent can include a mixture of alcohols. For example, industrial grade lauryl alcohol contains from about 60% to about 71% lauryl alcohol, from about 25% to about 31% myristyl alcohol, and from about 5% to about 8% cetyl alcohol.

The coal slurry entering the extraction reactor 501 can be formed with the same or different solvent.

In the extraction reactor 501, the coal-based feedstock is contacted with a solvent so as to achieve solvent extraction and/or chemical modification. During the extraction process, the reactor vessel (for example, the extraction reactor 501) can be operated under various conditions effective to extract the coal.

The extraction reactor 501 can be pressurized with a non-reactive gas such as N₂ or argon. The extraction reactor can be operated at a pressure that is from about 50 psi (about 0.34 MPa) to about 500 psi (3.45 MPa), such as from about 200 psi (about 1.4 MPa) to 360 psi (about 2.5 MPa), or from about 75 psi (about 0.52 MPa) to about 300 psi (about 2.1 MPa), such as from about 100 psi (about 0.69 psi) to about 250 psi (about 1.7 MPa), such as from about 115 psi (about 0.79 MPa) to about 200 psi (about 1.4 MPa), such as from about 125 psi (about 0.86 MPa) to about 175 psi (about 1.2 MPa), such as from about 135 psi (about 0.93 MPa) to about 165 psi (1.14 MPa), such as about 150 psi (1.03 MPa), though other values are contemplated. Any of the foregoing numbers can be used singly to describe an open-ended range or in combination to describe a close-ended range.

The extraction reactor 501 can be heated to a temperature that is from about 250° C. to about 450° C., such as from about 275° C. to about 425° C., such as from about 300° C. to about 400° C., such as from about 325° C. to about 390° C., such as from about 350° C. to about 380° C., such as from about 360° C. to about 370° C., though other values are contemplated. Any of the foregoing numbers can be used singly to describe an open-ended range or in combination to describe a close-ended range. In some embodiments, the extraction reactor 501 can be heated at or near (for example, ±10%) a temperature at which the solvent boils.

The temperature of the extraction reactor 501 can be maintained by a thermal control system, such as an electric clamshell heater. In some embodiments, the pressure of the extraction reactor 501 can be set to a certain pressure to keep the solvent in the liquid state. As will be generally understood by one of skill in, a variety of temperature, pressure, and flow rate conditions are compatible with the apparatus and processes described herein.

In some embodiments, a weight ratio of solvent to coal can be from about 1:1 to about 50:1, such as from about 5:1 to about 30:1, such as from about 10:1 to about 20:1, though other values are contemplated. Any of the foregoing numbers can be used singly to describe an open-ended range or in combination to describe a close-ended range.

The rotatable members 103 can be rotated at any suitable speed. In some embodiments, the rotatable members 103 can be rotated at a speed of greater than 1 revolutions per minute (rpm), about 500 rpm or less, or combinations thereof, such as from about 10 rpm to about 450 rpm, such as from about 50 rpm to about 400 rpm, such as from about 100 rpm to about 350 rpm, such as from about 150 rpm to about 300 rpm, such as from about 200 rpm to about 250 rpm, or from about 10 rpm to about 100 rpm, such as from about 20 rpm to about 90 rpm, such as from about 30 rpm to about 80 rpm, such as from about 40 rpm to about 70 rpm, such as from about 50 rpm to about 60 rpm, or about 30 rpm, though other values are contemplated. Any of the foregoing numbers can be used singly to describe an open-ended range or in combination to describe a close-ended range.

The members 113 (for example, agitators, sweeper arms, etc.) can be operated at any suitable agitation rate. In some examples, suitable agitation rates of the members can include a speed of greater than 1 revolutions per minute (rpm), about 500 rpm or less, or less than about 150 rpm, such as from about 10 rpm to about 100 rpm, such as from about 20 rpm to about 90 rpm, such as from about 30 rpm to about 80 rpm, such as from about 40 rpm to about 70 rpm, such as from about 50 rpm to about 60 rpm, or about 30 rpm, though other values are contemplated. Any of the foregoing numbers can be used singly to describe an open-ended range or in combination to describe a close-ended range.

Processes described herein can enable, for example, coal residence times in the extraction reactor that are significantly improved over conventional technologies. As discussed above, conventional technologies are characterized by coal residence times of only 1 hour or less, causing poor extraction yields (no more than 30%) and poor extraction efficiency.

In contrast, embodiments described herein can enable coal residence times of 1 hour or more, such as about 2 hours or more, about 24 hours or less, or combinations thereof, such as from about 3 hours to about 15 hours, such as from about 4 hours to about 12 hours, such as from about 5 hours to about 10 hours, such as about 7 hours or about 9 hours, though other values are contemplated. Any of the foregoing numbers can be used singly to describe an open-ended range or in combination to describe a close-ended range. Coal residence time is calculated based on extraction yields obtained from the coal. Coal extraction yield is calculated from the amount of coal fed into the system (weight, dry basis) versus the amount of extract product (weight) acquired. Total extract weight is subtracted from the total coal fed weight, and this quantity is then divided by the total coal fed weight and subtracted from 1. The acquired number is then multiplied by 100 to get the percent extraction yield.

The significantly higher coal residence times can enable, for example, obtaining higher extraction yields, higher extraction efficiency, and/or improved coal extract (for example, desired product) characteristics, among other benefits relative to conventional technologies. In some embodiments, apparatus and processes described herein can provide a coal conversion that is about 30% or more, such as from about 30% to about 93%, such as from about 40% to about 91%, such as from about 50% to about 86%, such as from about 60% to about 85%, such as from about 70% to about 80%, though other values are contemplated. Any of the foregoing numbers can be used singly to describe an open-ended range or in combination to describe a close-ended range. Conversion is based on a comparison of the weight of the material loaded into the reactor vessel (for example, extraction reactor 501) with the weight of the material collected after an extraction process was completed. The conversion can be higher or lower depending on the amount of ash in the coal.

Processes described herein can convert at least 3% by mass of the coal-based feedstock to the soluble phase product, such as about 10% by mass or more, such as about 25% by mass or more, such as about 50% by mass or more, such as about 70% by mass or more, such as about 80% mass or more, such as about 85% by mass or more, such as about 90% or more, such as about 95% or more. In some examples, processes described herein can convert from about 3% to about 95% by mass of the coal-based feedstock to the soluble phase product. Processes described herein can be performed as a flow through process, a batch process, a co-current process, a counter-current process, or combinations thereof.

In another embodiment, a process for treating (or extracting or processing) a coal-based feedstock to produce a high value product is provided. The process for treating can be performed with various apparatus described herein, for example, apparatus 100, extraction reactor 501, and plant 500, among other apparatus.

Embodiments of the processes for extracting coal (described above) and embodiments for the process for treating can be combined and/or substituted.

The process for treating the coal-based feedstock can include contacting a coal-based feedstock with a solvent under solvent treatment conditions for generating a soluble phase product (for example, coal extract) and a remainder insoluble phase product (for example coal residue). In some embodiments, the process for treating the coal-based feedstock can further include fractionating the soluble phase product generating at least two fractions under conditions such that at least one of said fractionated products comprises a high value product.

Implementations of the process for treating the coal-based feedstock can include one or more of the following. The coal-based feedstock can be at least partially derived from coal. In some embodiments, the coal-based feedstock includes a coal selected from the group consisting of sub-bituminous coal, lignite coal, anthracite coal, and combinations thereof. The coal-based feedstock can be at least partially derived from sub-bituminous coal or a derivative thereof. The coal-based feedstock can be generated by thermal treatment of coal or a derivative thereof, such as drying, pyrolysis, heating, or combinations thereof, among others. The coal-based feedstock can be generated by mechanical processing of coal or a derivative thereof such as grinding, pulverizing, sieving, changing particle size, formation of a slurry, or combinations thereof, among others.

The contacting operation of the process for treating the coal-based feedstock can include extracting the coal-based feedstock with the solvent, chemically reacting the coal-based feedstock with the solvent, or combinations thereof. Operating pressures, temperatures, flow rates, rotational speeds of various elements, among other operating parameters are described above and can be utilized during the contacting operation.

In some examples, the contacting operation of the process for treating the coal-based feedstock can be performed at a pressure high enough such that the solvent is at least partially a liquid during the contacting. The contacting can be performed at a pressure high enough such that the solvent is at least partially a dense supercritical fluid during the contacting. The contacting can be performed at supercritical fluid conditions. The contacting can be performed using a countercurrent flow. The contacting can be performed using a countercurrent extraction.

In some embodiments, the contacting operation of the process for treating the coal-based feedstock can be performed as a flow through process, a batch process, a co-current process, a counter-current process, or combinations thereof.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used (for example, amounts, dimensions, et cetera) but some experimental errors and deviations should be accounted for.

### EXAMPLES

The examples compare embodiments of apparatus 100 described herein with a disc and donut staging internals system. The examples illustrate the marked improvement in coal residence time obtained by embodiments described herein.

### Example 1: Internals Investigated

### Example 1.A. Comparative: Disc and Donut Staging Internals

A disc and donut staging internals system was utilized as a comparative example. The disc and donut staging internals system utilized a scaffolded stationary assembly combined with a rotating stir shaft assembly. The disc and donut staging internals system included a top filter stage, four disc and donut style stages, four left-hand drive impellers, and a support ring. Three ¼-inch stainless-steel rods were used as stationary scaffolding to support the filter and donut stages. A ⅜-inch stainless-steel rod is used as the stir shaft to which the impellers and discs are mounted. The discs, donuts, and support rings were all cut out of 0.105-inch thick 316 stainless-steel sheets using a water jet. Small discs are placed below the larger donut-style stationary discs making up the bottom platform of each stage. The donut ring and smaller disc pieces are used together to form one stage of the disc and donut staging internals system. A set gap between the upper donut ring and lower smaller disc was used.

The larger donut rings had an outside diameter of 5.7 inches with a donut hole inner diameter of 2.5 inches. There were also three ¼-inch diameter thru holes 2.5 inches from the center of the donut ring evenly spaced 120° apart used for mounting the donut discs to the scaffolding. The smaller discs had an outside diameter of 3 inches and a ⅜-inch thru hole through the center of the disc for the stir shaft. Two-piece stainless-steel shaft collars were used to fix the disc positions on the ¼-inch scaffolding and ⅜-inch stir shaft. The 3-inch impellers are positioned inside each stage and fixed to the stir shaft via setscrews. The disc and donut staging internals system were installed in a reactor.

### Example 1.b. Example Internals

Two different example internals were made, each having different openings through which coal passes through various stages of the apparatus. Both example internals provide an illustrative, but non-limiting, example of apparatus 100. FIGS. 6A-6F show images of internals made and are described above. The example internals accommodated residence times of about four hours or more.

The example internals included a scaffolded stationary assembly combined with a rotating stir shaft assembly. Periodically aligning pie-shaped orifices at each stage were used as the mechanism to allow coal particles to pass through the reactor. Six stages made up of a larger stationary disc sitting above a smaller rotating disc were designed for these internals. Two sets of larger and smaller discs were made with differing size of pie openings.

The example internals included a filter stage (for example, above the filter 116), six drop-through stages (for example, stages 121), six sweeper arms (for example, members 113), and a support ring for example, support ring 115b). Three ¼-inch stainless-steel rods (for example, stationary shafts 109) were used as stationary scaffolding to support the filter and drop-through stages. A ⅜-inch stainless-steel rod was used as the stir shaft (for example, rotatable shaft 111) to which the sweeper arms and rotating discs (for example, rotatable members 103) were mounted to. The stationary larger discs, rotating smaller discs, support rings, and sweeper arms were cut out of 0.105-inch thick 316 stainless-steel sheets using a water jet.

Both sets of the larger stationary discs (for example, stationary member 101) included an outside diameter of about 5.7 inches, a ˜0.39-inch thru hole (for example, opening 205) at the center, three ˜0.27-inch thru holes (for example, openings 203) that were about 2.5 inches from the center of the disc evenly spaced about 120° apart (for example, A1). Both sets of stationary discs included pie openings (for example, stationary member opening 107). The pie openings of the first set of stationary discs included a tip (for example, vertex 214) positioned about 0.5 inches from the center of the discs, sides of about 1.20 inches length (for example, length L1 of sides 210), an arc (for example, arc length A2 of third side 212) of about 15°, and a vertex angle (for example, vertex angle θ1) of about 15°. The pie openings of the second set of stationary discs included a tip (for example, vertex 264) positioned about 0.5 inches from the center of the discs, sides of about 1.18 inches length (for example, length L1 of sides 260), an arc (for example, arc length A2 of third side 262) of about 28.4°, and a vertex angle (for example, vertex angle θ2) of about 28.40.

Both sets of the smaller rotating discs (for example, rotatable member 103) included an outside diameter of about 4.0 inches, a ˜0.39-inch thru hole (for example, opening 301) at the center. The pie openings of the first set of rotatable discs included a tip (for example, vertex 314) positioned about 0.5 inches from the center of the discs, sides of about 1.20 inches length (for example, length L2 of sides 310), an arc (for example, arc length A3 of third side 312) of about 15°, and a vertex angle (for example, vertex angle θ3) of about 15°. The pie openings of the second set of rotatable discs included a tip (for example, vertex 364) positioned about 0.5 inches from the center of the discs, sides of about 1.18 inches length (for example, length L2 of side 360), an arc (for example, arc length A3 of side 362) of about 28.6°, and a vertex angle (for example, vertex angle θ4) of about 28.60.

The coal sweeper arms (for example, members 113) included sides of about 1.81 inches in length (for example, length L3 of sides 402) and about 0.75 inches in width (for example, width W1 of the second pair of opposing sides 404a, 404b). The sweeper arms were about 0.06 inches thick (for example, T as shown in the schematic side view 450). The sweeper arms also include a symmetrical tab (for example, indent 410) to provide space for a shaft collar to be welded to the sweeper arm. The tab had a width (for example, width W2 of side 407) of about 0.39 inches and a length (for example, length L4 of sides 412) of about 0.25 inches. The sweeper arms were cut out of a 0.060 thick 316 stainless-steel sheet using a waterjet.

### Example 2: Extraction

### Example 2.a. Reactor Vessel

The comparative example internals (disc and donut staging internals) and the two sets of example internals were individually investigated for solvent extraction of coal. The internals were installed in an upright, vertical position in a reactor vessel for the investigations.

A counter-current reactor vessel utilized for the investigations was constructed out of five different pieces. A 6-inch, schedule 80, 316 stainless-steel, seamless 4-foot pipe; a 600-lb class 6-inch pipe slip-on flange; a reactor head; a 6-inch to 1-inch reducer; and a flanged tee. All fittings on the reactor pipe housing were threaded in and then welded.

The reactor housing pipe included four process flow ports and six instrumentation ports. Two inlet ports located on the same side of the pipe were used for slurry feed and solvent feed. The slurry inlet was a ½-inch National pipe thread (NPT) threaded hole located 18 inches from the top of the reactor housing pipe. The solvent inlet was a ¼-inch NPT threaded hole located 40 inches from the top of the reactor housing pipe. Outlet ports were located on a 90° offset side from the inlet side of the reactor housing pipe. The product outlet was a ½-inch NPT threaded hole located 10.5 inches from the top of the reactor housing pipe. The overpressure knockout outlet was a ¾-inch NPT threaded hole located 40 inches from the top of the reactor housing pipe. Instrumentation ports were located on the side opposite of the inlet side of the reactor housing pipe. Five ¼-inch NPT threaded thermocouple ports were located 19 inches, 24 inches, 29 inches, 34 inches, and 40 inches from the top of the reactor housing pipe. A ¼-inch NPT threaded pressure transducer port was located 42 inches from the top of the reactor housing pipe, vertically in-line with the thermocouple ports.

The reactor head was modeled as a standard 6-inch 600-lb class blind flange but with a larger thickness. The head was specified to be 2.196 inches thick, with a 13.5-inch outside diameter, and 12 evenly spaced 1.125-inch thru bolt holes on a bolt-circle radius of 5.75 inches. A 1/16-inch centered sealing 8.5-inch diameter raised face was specified on the sealing surface of the reactor head. A 1.09-inch deep tapped hole with 1-¼-12 UNF thread (Unified National Fine thread) was added to the center of the reactor head for mounting the Magnetic drive. Two ¼-inch NPT threaded thermocouple inlets were located 30° apart from each other on a 2.25-inch radius bolt circle. Two ⅛-inch NPT threaded gas ports were located 90° apart from each other on a 2.25-inch radius bolt circle. Twelve 1-inch grade-8 bolts were used to mount the reactor head to the slip-on flange located at the top of the reactor housing pipe. A high-temperature 304 stainless-steel, ANSI class 600 metallic gasket with graphite sealing element filler was used to maintain a seal between the reactor housing pipe slip on flange and reactor head.

To facilitate a smooth transition for the coal residue slurry exiting out through the bottom of the reactor and to the residue filter, a custom reducing butt-weld union was designed and machined. The piece was fabricated out of a 7-inch long, 7-inch diameter, 316 stainless-steel cylinder block. The reducing transition at the large end was designed to match the inside (5.76-inch) and outside (6.63-inch) diameters of the reactor housing pipe. The outlet of the transition was designed to have an inside diameter of 1 inch and an outside diameter of 3 inches to accommodate a flange connection. Four ⅜-inch threaded bolts holes were included for the 1-inch flange connection.

After all the individual vessel pieces of the reactor were completed, the 600-lb class slip on flange was welded to the top of the reactor housing pipe. The 6-inch by 1-inch reducer piece was butt-welded to the bottom of the reactor housing pipe. All inlet/outlet and instrumentation reactor housing pipe fittings were threaded in and then welded to the reactor housing pipe. Fittings were all straight unions with NPT male thread on one side and Swagelok compression tube fitting on the other side. All appropriate male NPT to Swagelok unions were threaded into the reactor head and polytetrafluoroethylene (PTFE) tape was used as sealant.

Extract product stream exiting the reactor passes through a servo motor actuated high-temperature bellows valve. This bellows valve was opened and closed based on continuous feedback from the pressure reading inside the reactor. As the extract product stream drops pressure through the bellows valve, the solvent is vaporized inside a flash drum downstream. Here, the extract product stream exiting the reactor was maintained at a minimum of about 340° C. prior to being partially vaporized using a pressure drop from about 150 psig to about 5 psig in the flash drum. Post vaporization, the product and solvent mixture was maintained at 260° C. A liquid stream was then taken from the flash drum and fed into a vacuum distillation tower to further purify the product and recover solvent.

The coal residue exited as a slurry at the bottom of the reactor and passes through a pneumatically actuated valve in pulses, using the pressure difference between the reactor and residue filter to transport it downstream.

### Example 2.b. Parameters and Non-Limiting Results for Extraction

For the investigations, industrial grade lauryl alcohol was used as the solvent. Industrial grade lauryl alcohol contains 60-71% lauryl alcohol, 25-31% myristyl alcohol, and 5-8% cetyl alcohol. Powder River Basin dried coal with a particle size between 0.25 mm and 1.65 mm was used for the extraction. During extraction, the reactor vessel was operated at a temperature of about 360° C. to 370° C. and pressures of about 150 psi. The solvent flow rate was about 6 kg/h. The coal slurry feed rate was about 5 kg/h. The solvent and slurry were fed to the reactor utilizing separate Moyno progressive cavity dosing pump. For the example internals described herein (Example 1B), the rotatable discs were caused to rotate at a speed of about 30 rpm, and the sweeper arms were caused to rotate at a speed of about 30 rpm.

Extraction was performed according to the following general procedure. The pressure of the reactor vessel was set to the selected pressure, and the solvent was flowed into the reactor vessel at the specified solvent flow rate. The temperature of the reactor was ramped to the selected temperature. The coal slurry was then fed to the reactor at the specified coal slurry feed rate. The extract product and coal residue were collected.

Using the disc and donut staging internals of Example 1.A, a coal residence time of 1 hour was achieved. The extraction yield for the disc and donut staging internals was determined to be 30% extraction by weight.

In contrast, the example internals of Example 1.B achieved a coal residence time of about 4.5 hours, representing a significant improvement in coal residence time. Using the example internals, the extraction yielded about 83% extraction by weight. Overall, the data indicated that the coal residence time had a significant impact on extraction yields. In addition, it was found that extraction product qualities can depend on the extraction yield, indicating that embodiments described herein can provide improved extraction product qualities over conventional technologies.

Successful pilot plant runs utilizing embodiments described herein were also completed with fully continuous delivery of coal slurry and fresh solvent streams to the extraction reactor. Here, greater than 9 hours of continuous running of the pilot plant were completed. In addition, pilot plant runs utilizing embodiments described herein can achieve an overall mass balance of about 95% or more.

Extract products generated using 1-dodecanol as the solvent fully dissolved in 1-dodecanol at temperatures above 140° C. Because of this solubility, the product separation scheme was determined to be relatively simple because no filtration operations were performed.

Extract products generated by 1-dodecanol extraction can be utilized for asphalt additives when, for example, the asphalt additives meet hardness specifications provided by the Western Research Institute. It was determined that that the lower extraction yields (as achieved by the disc and donut staging internals) produced extracts that were too soft for proper use as asphalt additives. In contrast, the extracts produced by utilizing example internals of the present disclosure were determined to meet hardness requirements to be used as an asphalt additive. Overall, it was found that the asphalt additives meeting specifications were achieved when, for example, extraction yields were above about 70%, and such extraction yields can be obtained with coal residence times of 4 hours or more. These relatively high coal residence times cannot be achieved by conventional technologies as conventional technologies lack, for example, internals that can slow coal settling through a counter-current extraction reactor. As described herein, embodiments of the present disclosure can slow down coal settling, and at the same time, provide sufficient agitation inside the reactor to promote good coal particle contact with fresh solvent. The examples illustrate that this can be achieved by, for example, a staged internals apparatus with stationary and rotatable, spinning discs or plates containing pie slice shaped openings, and agitation with coal sweeper arms and impellers attached to the rotating shaft inside the reactor.

### Embodiments Listing

The present disclosure provides, among others, the following embodiments, each of which can be considered as optionally including any alternate embodiments:

Clause A1. A continuous-flow extraction apparatus for extracting coal with a solvent, comprising:
an upright reactor vessel divided into a plurality of stages by pairs of horizontal circular plates, each pair of horizontal circular plates comprising:
   a stationary plate having a stationary plate opening through which coal particles pass through, the stationary plate opening occupying a portion of less than two quadrants of the stationary plate; and
   a rotatable plate coupled to a rotatable shaft, the rotatable shaft extending through the stationary plate, the rotatable plate having a rotatable plate opening through which the coal particles pass through, the rotatable plate opening occupying a portion of less than two quadrants of the rotatable plate,
wherein the Upright Reactor Vessel Comprises:
   a vessel inlet though which a coal slurry enters the upright reactor vessel, the vessel inlet positioned above the plurality of stages, the coal slurry comprising the coal particles and a solvent; and
   a vessel outlet positioned through which a coal residue exits the upright reactor vessel, the vessel outlet positioned below the plurality of stages.

Clause A2. The continuous-flow extraction apparatus of Clause A1, wherein the stationary plate opening, the rotatable plate opening or both are pie-shaped or triangular-shaped, the pie-shaped opening or triangular-shaped opening comprising:
a pair of sides connected at a vertex, the vertex having a vertex angle measured on an interior side of the pie-shaped opening or the triangular-shaped opening that is less than about 45°; and
an arc or a third side connecting the pair of sides and opposite to the vertex.

Clause A3. The continuous-flow extraction apparatus of Clause A1 or Clause A2, wherein:
the continuous-flow extraction apparatus further comprises an agitator located in one or more stages of the plurality of stages, the agitator coupled to the rotatable shaft.

Clause A4. The continuous-flow extraction apparatus of Clause A3, wherein:
the agitator is a rotating impeller or paddle;
the agitator operates at least partially independently of the rotatable shaft; or
combinations thereof.

Clause A5. The continuous-flow extraction apparatus of any one of Clauses A1-A4, further comprising:
a solvent inlet positioned below the plurality of stages; and
a means for injecting solvent in a counter-current manner to a flow of the coal particles.

Clause B1. An apparatus for solvent extraction of coal, the apparatus comprising:
a plurality of stationary members coupled to a stationary shaft, each stationary member having a stationary member opening, the stationary member opening does not extend over two quadrants of the stationary member;
a rotatable shaft extending through the plurality of stationary members;
a plurality of rotatable members coupled to the rotatable shaft, wherein:
   each rotatable member is paired with a stationary member; and
   each rotatable member has a rotatable member opening, the rotatable member opening configured to rotate relative to the stationary member opening, the rotatable member opening does not extend over two quadrants of the rotatable member; and
a plurality of members for agitating materials passing through the apparatus, the members for agitating materials coupled to the rotatable shaft, each member for agitating materials positioned between the paired stationary members and rotatable members.

Clause B2. The apparatus of Clause B1, wherein the stationary member opening, the rotatable member opening, or both are pie-shaped or triangular-shaped.

Clause B3. The apparatus of Clause B2, wherein the pie-shaped opening or triangular-shaped opening comprises:
a pair of sides connected at a vertex, the vertex having a vertex angle measured on an interior side of the pie-shaped opening or the triangular-shaped opening that is less than about 60°; and
an arc or a third side connecting the pair of sides.

Clause B4. The apparatus of any one of Clauses B1-B3, wherein the members are rotating impellers.

Clause B5. The apparatus of any one of Clauses B1-B4, wherein a first member for agitating materials of the plurality of members is positioned between a rotatable member and a stationary member.

Clause B6. A reactor vessel comprising the apparatus of any one of Clauses B1-B5.

Clause B7. The reactor vessel of Clause B6, wherein the reactor vessel is a counter-current reactor vessel, a continuous flow reactor vessel, or combinations thereof.

Clause B8. The reactor vessel of Clause B6 or Clause B7, further comprising:
a coal slurry inlet positioned above the plurality of stationary members and the plurality of rotatable members;
a coal extract outlet positioned above the plurality of stationary members and the plurality of rotatable members; and
a coal residue outlet positioned below the plurality of stationary members and the plurality of rotatable members.

Clause C1. A process for extracting coal, the process comprising:
introducing a coal slurry comprising coal and a solvent into a reactor vessel divided into a plurality of stages by pairs of horizontal circular plates, each pair of horizontal circular plates comprising:
   a stationary plate having a stationary plate opening through which coal passes through; and
   a rotatable plate having a rotatable plate opening through which the coal passes through, each rotatable member opening configured to rotate relative to each stationary member opening;
rotating the rotatable plate independent of the stationary plate such that (a) the rotatable plate opening aligns with the stationary plate opening and (b) the coal passes from stage to stage;
maintaining agitation in at least a portion of the stages by an agitator located in the stages; and
collecting a coal extract through a first outlet of the reactor vessel and a coal residue through a second outlet of the reactor vessel.

Clause C2. The process of Clause C1, wherein a majority of coal in the coal slurry introduced to the reactor vessel is maintained within the plurality of stages for a residence time of four hours or more.

Clause C3. The process of Clause C1 or Clause C2, further comprising:
injecting solvent through a solvent inlet positioned below the plurality of stages such that the solvent contacts the coal in a counter-current manner in the plurality of stages.

Clause C4. The process of any one of Clauses C1-C3, wherein the agitator is a rotating sweeper arm or a rotating impeller.

Clause C5. The process of any one of Clauses C1-C4, wherein the reactor vessel is divided into at least five stages.

Clause C6. The process of any one of Clauses C1-C5, wherein:
the coal is selected from the group consisting of sub-bituminous coal, lignite coal, anthracite coal, and combinations thereof;
the process further comprises injecting a hydrocarbon solvent, an alcohol solvent, or combinations thereof into the reactor vessel; or
combinations thereof.

Clause C7. The process of any one of Clauses C1-C6, further comprising:
pressurizing the reactor vessel to a pressure that is from about 8.5 bar (about 125 psi) to about 25 bar (about 360 psi);
operating the reactor vessel at a temperature that is from about 250° C. to about 400° C.; or
combinations thereof.

Embodiments of the present disclosure generally relate to apparatus for solvent extraction and to processes for solvent extraction. Embodiments described herein can enable, for example, coal residence times of about 4 hours or more. The longer residence times enabled by embodiments described herein can allow for improved extraction of volatiles or other products from coal. Here, the improved extraction can be observed by the higher yields of volatiles and products as well as the enhanced characteristics of the volatiles and products. In addition, unlike conventional technologies for extracting coal which are not continuous (for example, semi-batch), embodiments described herein can enable continuous counter-current extraction.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

References cited herein are incorporated by reference herein in their entirety to indicate the state of the art as of their publication or filing date and it is intended that this information can be employed herein, if needed, to exclude specific embodiments that are in the prior art.

For purposes of this present disclosure, and unless otherwise specified, the term “coupled” is used herein to refer to elements that are either directly connected or connected through one or more intervening elements.

As used herein, the indefinite article “a” or “an” shall mean “at least one” unless specified to the contrary or the context clearly indicates otherwise. For example, embodiments comprising “a rotating member” include embodiments comprising one, two, or more rotating members, unless specified to the contrary or the context clearly indicates only one rotating member is included.

While the foregoing is directed to embodiments of the present disclosure, other and further embodiments of the disclosure may be devised without departing from the basic scope thereof, and the scope thereof is determined by the claims that follow.

What is claimed is:

1. A continuous-flow extraction apparatus for extracting coal with a solvent, comprising:
an upright reactor vessel divided into a plurality of stages by pairs of horizontal circular plates, each pair of horizontal circular plates comprising:
a stationary plate having a stationary plate opening occupying a portion of less than two quadrants of the stationary plate; and
a rotatable plate coupled to a rotatable shaft, the rotatable shaft extending through the stationary plate, the rotatable plate having a rotatable plate opening occupying a portion of less than two quadrants of the rotatable plate,
wherein the upright reactor vessel comprises:
a vessel inlet configured to receive a coal slurry entering the upright reactor vessel, the vessel inlet positioned above the plurality of stages, the coal slurry comprising coal particles and a solvent; and
a vessel outlet positioned opposite the vessel inlet.

2. The continuous-flow extraction apparatus of claim 1, wherein the stationary plate opening, the rotatable plate opening or both are pie-shaped or triangular-shaped, the pie-shaped opening or triangular-shaped opening comprising:
a pair of sides connected at a vertex, the vertex having a vertex angle measured on an interior side of the pie-shaped opening or the triangular-shaped opening that is less than about 45°; and
an arc or a third side connecting the pair of sides and opposite to the vertex.

3. The continuous-flow extraction apparatus of claim 1, wherein the continuous-flow extraction apparatus further comprises:
an agitator located in one or more stages of the plurality of stages, the agitator coupled to the rotatable shaft.

4. The continuous-flow extraction apparatus of claim 3, wherein:
the agitator is a rotating impeller or paddle;
the agitator operates at least partially independently of the rotatable shaft; or
combinations thereof.

5. The continuous-flow extraction apparatus of claim 1, further comprising:
a solvent inlet positioned below the plurality of stages; and
a means for injecting solvent in a counter-current manner to a flow of the coal particles.

6. An apparatus for solvent extraction of coal, the apparatus comprising:
a plurality of stationary members coupled to a stationary shaft, each stationary member having a stationary member opening, the stationary member opening does not extend over two quadrants of the stationary member;
a rotatable shaft extending through the plurality of stationary members;
a plurality of rotatable members coupled to the rotatable shaft, wherein:
each rotatable member is paired with a stationary member; and
each rotatable member has a rotatable member opening, the rotatable member opening configured to rotate relative to the stationary member opening, the rotatable member opening does not extend over two quadrants of the rotatable member; and
a plurality of members for agitating materials passing through the apparatus, the members for agitating materials coupled to the rotatable shaft, each member for agitating materials positioned between the paired stationary members and rotatable members.

7. The apparatus of claim 6, wherein the stationary member opening, the rotatable member opening, or both are pie-shaped or triangular-shaped.

8. The apparatus of claim 7, wherein the pie-shaped opening or triangular-shaped opening comprises:
a pair of sides connected at a vertex, the vertex having a vertex angle measured on an interior side of the pie-shaped opening or the triangular-shaped opening that is less than about 60°; and
an arc or a third side connecting the pair of sides.

9. The apparatus of claim 6, wherein the members are rotating impellers.

10. The apparatus of claim 6, wherein a first member for agitating materials of the plurality of members is positioned between a rotatable member and a stationary member.

11. A reactor vessel comprising the apparatus of claim 6.

12. The reactor vessel of claim 11, wherein the reactor vessel is a counter-current reactor vessel, a continuous flow reactor vessel, or combinations thereof.

13. The reactor vessel of claim 11, further comprising:
a coal slurry inlet positioned above the plurality of stationary members and the plurality of rotatable members;
a coal extract outlet positioned above the plurality of stationary members and the plurality of rotatable members; and
a coal residue outlet positioned below the plurality of stationary members and the plurality of rotatable members.

14. A process for extracting coal, the process comprising:
introducing a coal slurry comprising coal and a solvent into a reactor vessel divided into a plurality of stages by pairs of horizontal circular plates, each pair of horizontal circular plates comprising:
a stationary plate having a stationary plate opening through which coal passes through; and
a rotatable plate having a rotatable plate opening through which the coal passes through, each rotatable member opening configured to rotate relative to each stationary member opening;
rotating the rotatable plate independent of the stationary plate such that (a) the rotatable plate opening aligns with the stationary plate opening and (b) the coal passes from stage to stage;
maintaining agitation in at least a portion of the stages by an agitator located in the stages; and
collecting a coal extract through a first outlet of the reactor vessel and a coal residue through a second outlet of the reactor vessel.

15. The process of claim 14, wherein a majority of coal in the coal slurry introduced to the reactor vessel is maintained within the plurality of stages for a residence time of four hours or more.

16. The process of claim 14, further comprising:
injecting solvent through a solvent inlet positioned below the plurality of stages such that the solvent contacts the coal in a counter-current manner in the plurality of stages.

17. The process of claim 14, wherein the agitator is a rotating sweeper arm or a rotating impeller.

18. The process of claim 14, wherein the reactor vessel is divided into at least five stages.

19. The process of claim 14, wherein:
the coal is selected from the group consisting of sub-bituminous coal, lignite coal, anthracite coal, and combinations thereof;
the process further comprises injecting a hydrocarbon solvent, an alcohol solvent, or combinations thereof into the reactor vessel; or
combinations thereof.

20. The process of claim 14, further comprising:
pressurizing the reactor vessel to a pressure that is from about 8.5 bar (about 125 psi) to about 25 bar (about 360 psi);
operating the reactor vessel at a temperature that is from about 250° C. to about 400°C.; or
combinations thereof.
